(19) United States
(12) Patent Application Publication
(10) Pub. No.: US 2025/0181003 A1
(43) Pub. Date: Jun. 5, 2025

(54) TONER

(71) Applicant: CANON KABUSHIKI KAISHA, Tokyo (JP)

(72) Inventors: DAI NOZAKI, Shizuoka (JP); KENJI OOKUBO, Shizuoka (JP); MASASHI UNO, Shizuoka (JP); SHOHEI KOTOTANI, Shizuoka (JP)

(21) Appl. No.: 18/962,739

(22) Filed: Nov. 27, 2024

(30) Foreign Application Priority Data
Dec. 1, 2023 (JP) 2023-203618

(51) Int. Cl. G03G 9/097; G03G 9/087

(52) U.S. Cl. CPC G03G 9/09791; G03G 9/08708; G03G 9/09725

(57) ABSTRACT

A toner includes toner particles. A cohesion cluster containing fine silica particles and a binder component is present on surfaces of the toner particles. The toner includes fatty acid metal salt particles. An arithmetic mean value of a Feret diameter of the cohesion cluster is 1,000 to 8,000 nm. A number percentage CI of toner particles having the cohesion cluster is 1 to 15 number %. Number percentages of toner particles having the cohesion cluster in the toner after treatment under ultrasonic wave conditions A and B are represented by Ca and Cb, respectively. CI, Ca, and Cb satisfy formulae (1) and (2): ultrasonic wave condition A: output frequency 30 kHz, output capacity 0.75 W, irradiation time 300 s, ultrasonic wave condition B: output frequency 30 kHz, output capacity 25 W, irradiation time 300 s

$$0.9 \leq Ca / CI \leq 1. \qquad Formula ( 1 )$$

$$0.1 \leq Cb / CI \leq 0 \text{.40} . \qquad Formula ( 2 )$$

### BACKGROUND

### Technical Field

The present disclosure relates to a toner used in an image forming method such as electrophotography.

### Description of the Related Art

Methods for visualizing image information through electrostatic latent images, for example, electrophotography, are applied to copying machine, multifunction apparatuses, and printers. In recent years, with the diversification of the purpose of use, electrophotographs and toner cartridges have been required to have even longer lifetime and higher image quality.

In order to maintain high image quality throughout the lifetime, it is effective to control surface characteristics of a toner so that they do not change throughout the lifetime. In a typical electrophotographic process, surface characteristics of a toner are controlled by disposing an organic or inorganic fine powder, which is commonly called an external additive, on the toner surface. Furthermore, in order to provide stable images throughout the lifetime in various regions around the world, it is necessary to maintain characteristics of a toner even in various environments. External additives play an important role in such a toner design. In general, an external additive that is often used is silica, and silica imparts flowability to toners and plays an important role in generation and maintenance of charges due to triboelectric charging. In addition to silica, various external additives such as titanium oxide and strontium titanate are studied and used, and each provide toners with characteristics and features for printing desired images.

Studies have also been conducted on using an external additive in the form of aggregates rather than single particles. For example, Japanese Patent Laid-Open No. 2016-65963 discloses a toner that can achieve high image quality even in high-temperature, high-humidity environments by using an aggregate of silica.

As described above, external additives play an important role in influencing characteristics of toners; however, in electrophotographic printers with longer lifetime, it is difficult to maintain the characteristics throughout the lifetime. A toner is mixed and rubbed in the process of printing. In the case of a printer with a long lifetime, since the process is repeatedly performed many times, the surface of the toner cannot maintain the initial state, and an external additive is embedded in or comes off from a toner base material, which appears on an image as an image defect.

Various attempts have been made to improve such durability of a toner. For example, Japanese Patent Laid-Open No. 2010-134220 discloses a toner in which embedding and separation of an external additive are suppressed even in high-speed apparatuses due to the presence of a certain amount of particles formed by aggregation of two or more silica particles with a primary particle diameter of 50 nm to 150 nm.

As described above, in order to achieve high image quality throughout a long lifetime, toners having various external additives have been proposed to date.

However, in models with higher speed and longer lifetime, it is difficult to maintain the state of presence of an external additive so as to not to change from the beginning to the latter half of the lifetime. Furthermore, in order to provide stable images in various environments, in particular, it is necessary to cope with high-temperature, high-humidity environments. Under humid conditions, toner particles are likely to aggregate together and have insufficient flowability. Accordingly, this tends to cause melt adhesion of the toner to a developing blade. When the external additive and the toner are accumulated in a melt-adhesion portion, they appear as a stripe on an image (development stripe).

If the amount of external additive is increased, the effect lasts for a longer time, but an adverse effect due to soiling of a member by the external additive becomes significant. For example, in a cleaning unit, part of an external additive may pass through the cleaning unit and soil an electroconductive member. If this phenomenon occurs, the whole of the electroconductive member is sparsely soiled, and unevenness of the potential on a photosensitive member may be thereby generated, resulting in an adverse effect of uneven density of an image.

These disadvantages can be more significant disadvantages in long-lifetime electrophotographic systems, in which the toner surface is continuously repeatedly damaged, and soiling of a member is continued to be accumulated.

From this viewpoint, in longer-lifetime electrophotographic systems, there is room for further improvement in maintaining flowability of a toner without a change from the beginning to the latter half of the lifetime, and the adverse effect in an image due to soiling of the electroconductive member.

### SUMMARY

In view of the above disadvantages, the present disclosure provides a toner that maintains flowability throughout a long lifetime particularly even in a high-temperature, high-humidity environment, that is less likely to cause an adverse effect in an image due to toner aggregation, that is also less likely to cause an adverse effect in an image due to soiling of an electroconductive member, and that can achieve high image quality for a long lifetime.

The present disclosure provides a toner including toner particles, in which a cohesion cluster containing fine silica particles and a binder component is present on surfaces of the toner particles, and the toner further includes particles of a fatty acid metal salt, an arithmetic mean value Ag of a Feret diameter of the cohesion cluster is 1,000 nm or more and 8,000 nm or less, a number percentage of toner particles having the cohesion cluster is represented by CI (number %), CI is 1 number % or more and 15 number % or less, and a number percentage of toner particles having the cohesion cluster in the toner after being treated under an ultrasonic wave condition A is represented by Ca (number %), and a number percentage of toner particles having the cohesion cluster in the toner after being treated under an ultrasonic wave condition B is represented by Cb (number %), CI, Ca, and Cb satisfy formulae (1) and (2):
ultrasonic wave condition A: output frequency 30 kHz, output capacity 0.75 W, and irradiation time 300 s
ultrasonic wave condition B: output frequency 30 kHz, output capacity 25 W, and irradiation time 300 s

$$0.9 \leq Ca / CI \leq 1. \qquad Formula ( 1 )$$

$$0.1 \leq Cb / CI \leq 0 \text{.40} . \qquad Formula ( 2 )$$

Further features of the present disclosure will become apparent from the following description of exemplary embodiments with reference to the attached drawings.

### BRIEF DESCRIPTION OF THE DRAWINGS

FIG. 1 is a representative drawing of a toner having a cohesion cluster.

FIG. 2 is an example of an image obtained by performing a predetermined process using ImageJ on an analyzed image obtained in a method for checking the dispersed state of a binder component contained in a cohesion cluster.

FIG. 3 is an example of an image in which the midpoint of the image of FIG. 2 is defined as a reference point, and a total of 18 line segments are drawn at intervals of 10° from one end to the other end of the image so as to pass through the reference point.

FIG. 4 is a schematic view of a section of a toner having a cohesion cluster.

### DESCRIPTION OF THE EMBODIMENTS

In the present disclosure, the expression “XX or more and YY or less” or “XX to YY” indicating a numerial range means a numerical range including the lower limit and the upper limit, which are end points, unless otherwise specified. When numerical ranges are described in a stepwise manner, the upper limits and the lower limits of the numerical ranges can be appropriately combined. In the following dsciptions, a toner particle before a cohesion cluster is present on the surface of the toner particle may be referred to as a “toner core particle”.

### FEATURES OF THE DISCLOSURE

As described above, an external additive of a toner needs to have a capability of imparting flowability to the toner throughout the lifetime to assist charging, and the capability is even more required in a high-temperature, high-humidity environment, in which the toner is likely to aggregate.

One possible method for stably imparting flowability is to incorporate a large amount of external additive in the toner. When the external additive is present in a large amount, flowability of the toner increases, and necessary flowability is maintained even in the latter half of the lifetime and even in a high-temperature, high-humidity environment.

However, the presence of a large amount of external additive means that the external additive is likely to move from the toner to a member. Thus, soiling of the member is likely to be caused, and the external additive is likely to pass through a cleaning unit. In addition, when the external additive is likely to move from the toner to the member, the external additive is consumed at an initial stage, and it is difficult to maintain the effect throughout the long lifetime.

Accordingly, in order to maintain flowability through a longer lifetime and even in a high-temperature, high-humidity environment, it is necessary that a necessary external additive be continued to exist on the toner surface throughout the lifetime without relying on a large amount of external additive, and furthermore, in a high-temperature, high-humidity environment, it is necessary to create a state where a larger amount of external additive is present on the toner surface.

For these required characteristics, the present inventors have found that, with a toner having a main configuration described below, flowability can be maintained throughout a long lifetime, aggregation of the toner can be suppressed even in a high-temperature, high-humidity environment, an adverse effect in an image is less likely to be generated, and a high-quality electrophotographic image can be provided.

A toner includes toner particles, in which a cohesion cluster containing fine silica particles and a binder component is present on surfaces of the toner particles, and the toner further includes particles of a fatty acid metal salt. An arithmetic mean value Ag of a Feret diameter of the cohesion cluster is 1,000 nm or more and 8,000 nm or less, a number percentage of toner particles having the cohesion cluster is represented by CI (number %), and CI is 1 number % or more and 15 number % or less. A number percentage of toner particles having the cohesion cluster in the toner after being treated under an ultrasonic wave condition A is represented by Ca (number %), a number percentage of toner particles having the cohesion cluster in the toner after being treated under an ultrasonic wave condition B is represented by Cb (number %), and CI, Ca, and Cb satisfy formulae (1) and (2).
Ultrasonic wave condition A: output frequency 30 kHz, output capacity 0.75 W, and irradiation time 300 s
Ultrasonic wave condition B: output frequency 30 kHz, output capacity 25 W, and irradiation time 300 s

$$0.9 \leq Ca / CI \leq 1. \qquad Formula ( 1 )$$

$$0.1 \leq Cb / CI \leq 0.4 \qquad Formula ( 2 )$$

With regard to the mechanism by which the effect is achieved by the above combination of the cohesion cluster and the external additive, the present inventors consider the following.

The toner according to the present disclosure has, on surfaces of toner particles, fatty acid metal salt particles and a cohesion cluster containing fine silica particles and a binder component. The fatty acid metal salt particles may be included in the cohesion cluster or may be present on the surfaces of the toner particles as an external additive. The cohesion cluster has the binder component connecting components typified by fine silica particles together or connecting a toner particle and the cohesion cluster. Accordingly, unlike ordinary aggregates of fine silica particles, the components typified by fine silica particles, and the toner particle and the cohesion cluster are in a state of being less likely to separate.

In the toner according to the present disclosure, a number percentage of toner particles having the cohesion cluster is represented by CI (number %), and CI is 1 number % or more and 15 number % or less. A number percentage of toner particles having the cohesion cluster after the toner is treated under the above ultrasonic wave condition A is represented by Ca (number %), a number percentage of toner particles having the cohesion cluster after the toner is treated under the above ultrasonic wave condition B is represented by Cb (number %), and CI, Ca, and Cb satisfy the following.

$$0.9 \leq Ca / CI \leq 1. \qquad Formula ( 1 )$$

$$0.1 \leq Cb / CI \leq 0.4 \qquad Formula ( 2 )$$

More specifically, if the energy applied is weak, cohesion clusters neither collapse nor separate. If the energy applied is high, cohesion clusters collapse and separate. This indicates that since the energy applied is accumulated, when stirring is performed for a long time, cohesion clusters gradually collapse and separate. Specifically, at the initial stage of the lifetime, since the energy applied to cohesion clusters due to stirring and friction is weak, the cohesion clusters do not separate. Therefore, the above-described adverse effect of soiling of a member due to excessive supply of the external additive is not caused. When printing is continued and energy applied to the cohesion clusters due to stirring and friction is accumulated, the cohesion clusters collapse and separate from the toner. Since the main component of the separated cohesion clusters is an external additive component such as fine silica particles, the separated cohesion clusters adhere to the surfaces of toner particles as an external additive and provide, as a fresh external additive, the toner with flowability. The external additive can be successively supplied by this action from the cohesion clusters throughout the lifetime to thereby suppress the adverse effect in an image even in the latter half of the lifetime.

Moreover, the presence of the fatty acid metal salt particles provides this action with responsiveness to the environment. The fatty acid metal salt particles are a lubricant and have a strong hydrophobic action. In a high-temperature, high-humidity environment with a high water content, fatty acid metal salt particles in contact with cohesion clusters have repulsive force with surrounding components because the surrounding components are in a state of containing a large amount of water. In addition, the properties as the lubricant are also exhibited, and the fatty acid metal salt particles serve as starting points for the collapse of the cohesion clusters when energy is applied. This action accelerates separation of the cohesion clusters including the fatty acid metal salt particles from the toner in the high-temperature, high-humidity environment and supplies the cohesion clusters to the toner as an external additive in a large amount. Presumably, even in excess-water conditions, this can suppress aggregation of the toner, maintain flowability, and suppress an adverse effect in an image, such as a development stripe, due to toner melt adhesion.

Hereinafter, details including suitable ranges of the present disclosure will be described on the basis of the mechanism described above.

### Fatty Acid Metal Salt Particle, Cohesion Cluster, and Toner Particle

A toner according to the present disclosure contains particles of a fatty acid metal salt. The metal of the particles of the fatty acid metal salt may be a divalent or higher polyvalent metal, and the fatty acid metal salt may be a salt of at least one metal selected from the group consisting of zinc, calcium, magnesium, aluminum, and lithium. From the viewpoint of further improving cleaning properties in a very low-temperature, low-humidity environment, the central metal of the fatty acid metal salt can be zinc.

The fatty acid of the fatty acid metal salt particles is preferably a higher fatty acid having 8 or more and 28 or less (more preferably 12 or more and 22 or less) carbon atoms.

That is, the fatty acid metal salt particles are preferably particles of a fatty acid metal salt of a divalent or higher (more preferably divalent or trivalent, still more preferably divalent) polyvalent metal and a fatty acid having 8 or more and 28 or less (more preferably 12 or more and 22 or less) carbon atoms. Use of a fatty acid having 8 or more carbon atoms tends to suppress the generation of a free fatty acid. The amount of free fatty acid is preferably 0.20% by mass or less. When the number of carbon atoms of the fatty acid is 28 or less, the fatty acid metal salt particles do not have an excessively high melting point and are less likely to impair fixability. In particular, the fatty acid can be stearic acid. The divalent or higher polyvalent metal can include zinc.

Examples of the fatty acid metal salt constituting the fatty acid metal salt particles include metal stearates such as zinc stearate, calcium stearate, magnesium stearate, aluminum stearate, and lithium stearate; and zinc laurate.

The fatty acid metal salt particles are preferably contained in the toner in an amount of 0.1% by mass or more and 3.0% by mass or less, more preferably 0.2% by mass or more and 2.0% by mass or less. If the amount of fatty acid metal salt is excessively small, the effect of the present disclosure in coping with humid environments is not achieved. If the amount of fatty acid metal salt is excessively large, soiling of a member is worsened.

The form of the fatty acid metal salt particles contained in the toner according to the present disclosure may be as follows. The fatty acid metal salt particles may be contained in a cohesion cluster or present on the surface of a toner particle, or may be separately added as an external additive together with the inside of a cohesion cluster.

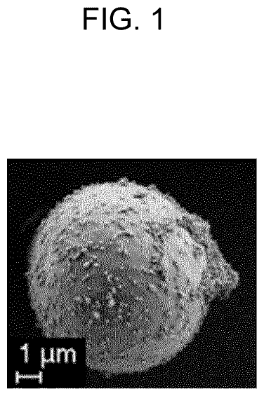

FIG. 1 is a representative drawing of a toner in which a cohesion cluster is present on the surface of a toner particle.

The cohesion cluster containing fine silica particles and a binder component may specifically include particles containing silica as a main component and a binder component capable of binding the particles together.

Examples of the particles containing silica as a main component include dry-process fine silica particles produced by vapor-phase oxidation of a silicon halide, so-called dry-process or fumed silica, and so-called wet-process fine silica particles produced from water glass or the like (hereinafter, also referred to as colloidal silica). These particles may be subjected to hydrophobization treatment. Examples of a treatment agent used for the hydrophobization treatment include silicone varnishes, modified silicone varnishes, silicone oils, modified silicone oils, silane compounds, silane coupling agents, other organosilicon compounds, and organotitanium compounds. These may be used alone or in combination of two or more thereof.

Primary particles of the fine silica particles preferably have a number-average particle diameter of 10 nm or more and 200 nm or less (more preferably 15 nm or more and 150 nm or less). The number-average particle diameter of primary particles of the fine silica particles may be determined using an enlarged photograph of the toner taken with a scanning electron microscope.

The cohesion cluster may contain, in addition to fine silica particles, for example, external additives typically used for electrophotographic toners, titanium oxide particles, strontium titanate particles, alumina particles, and fatty acid metal salt particles.

In particular, a cohesion cluster can contain fatty acid metal salt particles, and on a surface observed with a scanning electron microscope, an area fraction of the fatty acid metal salt particles in the cohesion cluster is preferably 2% or more and 30% or less relative to the entirety of the cohesion cluster.

The binder component capable of binding the fine silica particles together is required to be able to stick the particles with appropriate strength and not to cause any adverse effects even when subjected to mechanical stress or environmental changes such as temperature and humidity in the developing process. Examples of such a material include organic resins. In particular, vinyl resins and polyester resins can be suitably used. These resins can hold fine silica particles with appropriate sticking strength and enable the fine silica particles to be continuously supplied into the developing process as the toner is used. The binder component itself is also supplied into the developing process at the same time, and appropriate selection of the hardness of the binder component and responsiveness of the binder component to environmental changes such as temperature and humidity can reduce soiling of a member and changes in developing characteristics. Specific materials will be described in the section of a production method described later.

In the toner according to the present disclosure, a number percentage of toner particles having the cohesion cluster is represented by CI (number %), and CI needs to be 1 number % or more and 15 number % or less. If CI is excessively low, the number of toner particles including a cohesion cluster is excessively small, and thus the effects of the present disclosure are not achieved. If CI is excessively high, the number of toner particles including a cohesion cluster is excessively large, and thus soiling of an electroconductive member is worsened. CI is preferably 2 number % or more and 14 number % or less, more preferably 3 number % or more and 12 number % or less. CI can be controlled by adjusting production conditions such as the numbers of parts of materials charged, the types of materials, and stirring conditions.

Furthermore, in the toner according to the present disclosure, a number percentage of toner particles having the cohesion cluster in the toner after being treated under an ultrasonic wave condition A is represented by Ca (number %), a number percentage of toner particles having the cohesion cluster in the toner after being treated under an ultrasonic wave condition B is represented by Cb (number %), and it is necessary that CI, Ca, and Cb satisfy formulae (1) and (2).
Ultrasonic wave condition A: output frequency 30 kHz, output capacity 0.75 W, and irradiation time 300 s
Ultrasonic wave condition B: output frequency 30 kHz, output capacity 25 W, and irradiation time 300 s

$$0.9 \leq Ca / CI \leq 1. \qquad Formula ( 1 )$$

$$0.1 \leq Cb / CI \leq 0.4 \qquad Formula ( 2 )$$

More specifically, the range of Ca/CI needs to be 0.90 or more and 1.00 or less, and a Ca/CI smaller than 0.90 means that cohesion clusters are likely to separate even under weak shear. Therefore, cohesion clusters are rapidly consumed, the effect does not last long, and an electroconductive member is also likely to be soiled. A preferred range of Ca/CI is 0.95 or more and 1.00 or less. Ca/CI can be controlled by, for example, adjusting the types of materials such as the fine silica particles and the binder component and blending ratio of the materials.

The range of Cb/CI needs to be 0.10 or more and 0.40 or less. A Cb/CI larger than 0.40 means that cohesion clusters are unlikely to separate even under high shear, and thus the effects of the present disclosure are unlikely to be achieved. A preferred range of Cb/CI is 0.10 or more and 0.38 or less.

Cb/CI can be controlled by, for example, adjusting the types of materials such as the fine silica particles and the binder component and blending ratio of the materials.

Furthermore, an arithmetic mean value Ag of a Feret diameter of the cohesion cluster needs to be 1,000 nm or more and 8,000 nm or less. When the Feret diameter of the cohesion cluster is within the above range, the cohesion cluster is sufficiently large, and thus the supply of the toner with cohesion clusters to a developing portion is delayed, and the toner is stirred in a container for a longer time. This makes it easier for cohesion clusters to have an opportunity to separate. The arithmetic mean value Ag of a Feret diameter is preferably 1,300 nm or more and 7,500 nm or less, more preferably 1,500 nm or more and 7,000 nm or less. The arithmetic mean value Ag of a Feret diameter of the cohesion cluster can be controlled by, for example, adjusting the particle diameter of fine silica particles used, and production conditions such as the numbers of parts of materials charged, the blending ratio of the fine silica particles and the binder component, and stirring conditions.

Furthermore, on a surface of a toner particle having the cohesion cluster observed with a scanning electron microscope, an area fraction of the binder component of the cohesion cluster is preferably 5% or more and 50% or less relative to the entirety of the cohesion cluster. As described above, when cohesion clusters appropriately contain the binder component, the separation of the cohesion clusters from the toner is appropriately controlled, and the effects of the present disclosure are achieved at a high level. If the area fraction is smaller than this range, cohesion clusters are likely to separate and likely to soil an electroconductive member, and the effects are less likely to be achieved throughout a long lifetime. If the area fraction is larger than this range, cohesion clusters are unlikely to separate, and the effect of continuously improving flowability is unlikely to be achieved. The area fraction of the binder component of cohesion clusters can be controlled by, for example, adjusting production conditions such as the blending ratio of the fine silica particles and the binder component and stirring conditions.

Furthermore, the toner preferably includes, among toner particles having the cohesion cluster, toner particles having a cohesion cluster satisfying (a) below in an amount of 50 number % or more.

(a) In a binarized image of a backscattered electron image of a cohesion cluster taken with a scanning electron microscope, when the midpoint of the image of the cohesion cluster is defined as a reference point, and a total of 18 straight lines are drawn at intervals of 10° so as to pass through the reference point, the number A of straight lines having a line segment with a length of a continuous dark portion of 100 nm or more on the straight lines is 12 or more relative to the total of 18 straight lines.

Satisfying (a) above means that the resin component is included in the cohesion cluster in a uniformly dispersed manner. Accordingly, a variation in the move of cohesion clusters is less likely to occur, and the effects of the present disclosure are likely to be achieved. The amount is preferably 60 number % or more, more preferably 80 number % or more.

The number of toner particles having a cohesion cluster satisfying (a) above can be controlled by, for example, adjusting production conditions such as the blending ratio of the fine silica particles and the binder component and conditions for dispersing the fine silica particles and the binder component used.

Moreover, when a dispersion liquid prepared by treating the toner under the ultrasonic wave condition A above is measured with a flow particle image measuring apparatus, a presence ratio YA (number %) of particles with a size of less than 4 μm is preferably 20 number % or more and 50 number % or less. These fine particles contain, as a main component, cohesion clusters separated from the toner. The fine particles that are present from the early lifetime in an appropriate amount provide the toner with appropriate flowability and suppress an adverse effect in an image. If the amount is excessively small, the effect is not achieved. If the amount is excessively large, the adverse effect of soiling of a member appears.

The presence ratio YA (number %) of particles with a size of less than 4 μm can be controlled by, for example, adjusting production conditions such as the blending ratio of the fine silica particles and the binder component and conditions for dispersing the fine silica particles and the binder component used.

Components of Toner Particle Other than Cohesion Cluster

### Binder Resin

The toner particles contain a binder resin. The content of the binder resin is preferably 50% by mass or more relative to the total amount of resin components in the toner particles.

Examples of the binder resin include, but are not particularly limited to, styrene acrylic resins, epoxy resins, polyester resins, polyurethane resins, polyamide resins, cellulose resins, polyether resins, and resin mixtures and composite resins of the foregoing. From the viewpoint of low cost, availability, and good low-temperature fixability, a styrene acrylic resin and a polyester resin are preferred.

Examples of the styrene acrylic resin include polymers obtained from monofunctional polymerizable monomers or polyfunctional polymerizable monomers below, copolymers obtained by combining two or more of these, and mixtures thereof.

Examples of the monofunctional polymerizable monomers include: styrene derivatives such as styrene, α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, and p-phenylstyrene; acrylic polymerizable monomers such as methyl acrylate, ethyl acrylate, n-propyl acrylate, iso-propyl acrylate, n-butyl acrylate, iso-butyl acrylate, tert-butyl acrylate, n-amyl acrylate, n-hexyl acrylate, 2-ethylhexyl acrylate, n-octyl acrylate, n-nonyl acrylate, cyclohexyl acrylate, benzyl acrylate, dimethyl phosphate ethyl acrylate, diethyl phosphate ethyl acrylate, dibutyl phosphate ethyl acrylate, and 2-benzoyloxyethyl acrylate; methacrylic polymerizable monomers such as methyl methacrylate, ethyl methacrylate, n-propyl methacrylate, iso-propyl methacrylate, n-butyl methacrylate, iso-butyl methacrylate, tert-butyl methacrylate, n-amyl methacrylate, n-hexyl methacrylate, 2-ethylhexyl methacrylate, n-octyl methacrylate, n-nonyl methacrylate, diethyl phosphate ethyl methacrylate, and dibutyl phosphate ethyl methacrylate; methylene aliphatic monocarboxylic acid esters; vinyl esters such as vinyl acetate, vinyl propionate, vinyl butyrate, vinyl benzoate, and vinyl formate; vinyl ethers such as vinyl methyl ether, vinyl ethyl ether, and vinyl isobutyl ether; and vinyl ketones such as vinyl methyl ketone, vinyl hexyl ketone, and vinyl isopropyl ketone.

Examples of the polyfunctional polymerizable monomers include: diethylene glycol diacrylate, triethylene glycol diacrylate, tetraethylene glycol diacrylate, polyethylene glycol diacrylate, 1,6-hexanediol diacrylate, neopentyl glycol diacrylate, tripropylene glycol diacrylate, polypropylene glycol diacrylate, 2,2′-bis(4-(acryloxy·diethoxy)phenyl) propane, trimethylolpropane triacrylate, tetramethylolmethane tetraacrylate, ethylene glycol dimethacrylate, diethylene glycol dimethacrylate, triethylene glycol dimethacrylate, tetraethylene glycol dimethacrylate, polyethylene glycol dimethacrylate, 1,3-butylene glycol dimethacrylate, 1,6-hexanediol dimethacrylate, neopentyl glycol dimethacrylate, polypropylene glycol dimethacrylate, 2,2′-bis(4-(methacryloxy·diethoxy)phenyl) propane, 2,2′-bis(4-(methacryloxy·polyethoxy)phenyl) propane, trimethylolpropane trimethacrylate, tetramethylolmethane tetramethacrylate, divinylbenzene, divinylnaphthalene, and divinyl ether.

The polyester resin that can be used may be a product prepared by condensation polymerization of a carboxylic acid component and an alcohol component described below. Examples of the carboxylic acid component include terephthalic acid, isophthalic acid, phthalic acid, fumaric acid, maleic acid, cyclohexanedicarboxylic acid, and trimellitic acid. Examples of the alcohol component include bisphenol A, hydrogenated bisphenol, bisphenol A-ethylene oxide adduct, bisphenol A-propylene oxide adduct, glycerin, trimethylolpropane, and pentaerythritol.

The polyester resin may be a polyester resin containing a urea group. In the polyester resin, carboxy groups located at terminals or the like may not be capped.

### Coloring Agent and Magnetic Material

The toner particles may contain a coloring agent. The coloring agent may be a known pigment or dye. The coloring agent can be a pigment from the viewpoint of good weatherability.

Examples of cyan coloring agents include copper phthalocyanine compounds and derivatives thereof, anthraquinone compounds, and basic dye lake compounds.

Specific examples thereof include C.I. Pigment Blue 1, 7, 15, 15:1, 15:2, 15:3, 15:4, 60, 62, and 66.

Examples of magenta coloring agents include condensed azo compounds, diketopyrrolopyrrole compounds, anthraquinone compounds, quinacridone compounds, basic dye lake compounds, naphthol compounds, benzimidazolone compounds, thioindigo compounds, and perylene compounds.

Specific examples thereof include C.I. Pigment Red 2, 3, 5, 6, 7, 23, 48:2, 48:3, 48:4, 57:1, 81:1, 122, 144, 146, 150, 166, 169, 177, 184, 185, 202, 206, 220, 221, and 254 and C.I. Pigment Violet 19.

Examples of yellow coloring agents include condensed azo compounds, isoindolinone compounds, anthraquinone compounds, azo metal complexes, methine compounds, and allylamide compounds.

Specific examples thereof include C.I. Pigment Yellow 12, 13, 14, 15, 17, 62, 74, 83, 93, 94, 95, 97, 109, 110, 111, 120, 127, 128, 129, 147, 151, 154, 155, 168, 174, 175, 176, 180, 181, 185, 191, and 194.

Examples of black coloring agents include carbon black and coloring agents adjusted to black by using the above-described yellow coloring agents, magenta coloring agents, and cyan coloring agents.

These coloring agents may be used alone or as a mixture. Furthermore, these may be used in a solid solution state.

The coloring agent is preferably used in an amount of 1.0 part by mass or more and 20.0 parts by mass or less relative to 100.0 parts by mass of the binder resin.

The toner may be a magnetic toner containing a magnetic material. In this case, the magnetic material can also function as a coloring agent.

Examples of the magnetic material include iron oxides such as magnetite, hematite, and ferrite; metals such as iron, cobalt, and nickel, alloys of any of these metals and a metal such as aluminum, cobalt, copper, lead, magnesium, tin, zinc, antimony, beryllium, bismuth, cadmium, calcium, manganese, selenium, titanium, tungsten, or vanadium, and mixtures thereof.

### Release Agent

The toner particles may contain a release agent. The release agent is not particularly limited and may be a known wax.

Specific examples thereof include petroleum waxes such as paraffin wax, microcrystalline wax, and petrolatum and derivatives thereof; montan waxes and derivatives thereof; hydrocarbon waxes obtained by the Fischer-Tropsch process and derivatives thereof; polyolefin waxes such as polyethylene and derivatives thereof; and natural waxes such as carnauba wax and candelilla wax and derivatives thereof.

The derivatives also include oxides, block copolymers with vinyl monomers, and graft modified products.

Examples of waxes further include alcohols such as higher aliphatic alcohols; fatty acids such as stearic acid and palmitic acid, and acid amides, esters, and ketones thereof; hydrogenated castor oil and derivatives thereof, vegetable waxes, and animal waxes. These may be used alone or in combination.

In particular, when a polyolefin, a hydrocarbon wax obtained by the Fischer-Tropsch process, or a petroleum wax is used, developability and transferability tend to be improved.

An antioxidant may be added to the waxes as long as the above-described effects are not affected.

The content of the release agent is preferably 1.0 part by mass or more and 30.0 parts mass or less relative to 100.0 parts by mass of the binder resin or the polymerizable monomer that forms the binder resin.

The melting point of the release agent is preferably 30° C. or higher and 120° C. or lower, more preferably 60° C. or higher and 100° C. or lower.

The use of a release agent that exhibits the above thermal characteristics efficiently exhibits the release effect and ensures a wider fixing region.

### External Additives

An organic or inorganic fine powder may be added to the toner particles as necessary as long as the effects of the present disclosure are not impaired. The particle diameter of the organic or inorganic fine powder is preferably 1/10 or less of the weight-average particle diameter of the toner particles in view of durability when the fine powder is added to the toner particles.

Examples of the organic or inorganic fine powder include:
(1) flowability imparting agents: silica, alumina, titanium oxide, carbon black, and fluorocarbon,
(2) abrasives: metal oxides (for example, strontium titanate, cerium oxide, alumina, magnesium oxide, and chromium oxide), nitrides (for example, silicon nitride), carbides (for example, silicon carbide), and metal salts (for example, calcium sulfate, barium sulfate, and calcium carbonate),
(3) lubricants: fluoropolymer powders (for example, vinylidene fluoride and polytetrafluoroethylene) and fatty acid metal salts (for example, zinc stearate and calcium stearate), and
(4) charge control particles: metal oxides (for example, tin oxide, titanium oxide, zinc oxide, silica, and alumina), carbon black, and hydrotalcite.

The surface of the organic or inorganic fine powder may be subjected to a hydrophobization treatment to improve the flowability of the toner and uniformize the charging of the toner particles. Examples of treatment agents for the hydrophobization treatment of the organic or inorganic fine powder include unmodified silicone varnishes, modified silicone varnishes, unmodified silicone oils, modified silicone oils, silane compounds, silane coupling agents, other organosilicon compounds, and organotitanium compounds. These treatment agents may be used alone or in combination.

In particular, fine silicone resin particles can be contained as an external additive. Fine silicone resin particles are less likely to be embedded in the toner surface due to their elasticity and have high durability. Cohesion clusters separated from the toner have no difference from an ordinary external additive; therefore, when the cohesion clusters are present together with fine silicone resin particles, durability of separation is also improved, and thus a higher effect of suppressing adverse effects throughout the lifetime is achieved.

### Method for Producing Toner

An example of a method for producing the toner particles described above will be described below, but the method is not limited to the following.

The method for producing toner particles is not particularly limited, and, for example, a suspension polymerization method, a dissolution suspension method, an emulsion aggregation method, or a pulverization method can be employed. For example, a method for producing toner particles by the emulsion aggregation method is described below.

### Method for Producing Toner Particles (Toner Core Particles) by Emulsion Aggregation Method

### Step of Preparing Fine Resin Particle Dispersion Liquid

A fine resin particle dispersion liquid can be prepared by a known method, but the method is not limited thereto. For example, the method may be an emulsion polymerization method, a self-emulsification method, a phase-inversion emulsification method of emulsifying a resin by adding an aqueous medium to a solution of the resin dissolved in an organic solvent, or a forced emulsification method of forcibly emulsifying a resin by a treatment in an aqueous medium at a high temperature without using an organic solvent.

As one example, a method for preparing a fine resin particle dispersion liquid by the phase-inversion emulsification method will be described below.

A resin component is dissolved in an organic solvent in which the resin component is soluble, and a surfactant and a basic compound is added to the solution. In this case, if the resin component is a crystalline resin having a melting point, the resin component may be dissolved by heating to the melting point or higher. Subsequently, while stirring is performed with a homogenizer or the like, an aqueous medium is gradually added to the solution to precipitate fine resin particles. Subsequently, the solvent is removed by heating or reducing the pressure to prepare an aqueous dispersion liquid of the fine resin particles.

Here, the organic solvent used for dissolving the resin component may be any organic solvent than can dissolve the resin component. Specifically, examples thereof include toluene and xylene.

Examples of the surfactant used in the preparation step include anionic surfactants such as sulfates, sulfonates, carboxylates, phosphates, and soaps; cationic surfactants such as amine salts and quaternary ammonium salts; and nonionic surfactants such as polyethylene glycol, alkylphenol ethylene oxide adducts, and polyhydric alcohols.

Examples of the basic compound used in the preparation step include inorganic bases such as sodium hydroxide and potassium hydroxide, and organic bases such as ammonia, triethylamine, trimethylamine, dimethylaminoethanol, and diethylaminoethanol. The basic compounds may be used alone or in combination of two or more thereof.

### Preparation of Coloring Agent Dispersion Liquid

A coloring agent dispersion liquid can be prepared using a known dispersion method. For example, a typical dispersion device such as a homogenizer, a ball mill, a colloid mill, or an ultrasonic disperser can be used, and the method is not limited. A surfactant used during dispersion may be the surfactant described above.

### Preparation of Wax Dispersion Liquid

In the preparation of a wax dispersion liquid, a wax is dispersed in water together with a surfactant, a basic compound, and the like, the resulting liquid is then heated to a temperature equal to or higher than the melting point of the wax and subjected to a dispersion treatment using a homogenizer or a disperser configured to apply a strong shear force. Through this process, a wax dispersion liquid is prepared. The surfactant used during dispersion may be the surfactant described above. The basic compound used during dispersion may be the basic compound described above.

### Aggregate Particle Forming Step

In an aggregate particle forming step, first, the fine resin particle dispersion liquid, the coloring agent dispersion liquid, the wax dispersion liquid, etc. are mixed to prepare a liquid mixture. Subsequently, while heating is performed at a temperature equal to or lower than the melting point of the fine resin particles, the pH is made acidic to cause aggregation, thereby forming aggregate particles including fine resin particles, coloring agent particles, and release agent particles. Thus, an aggregate particle dispersion liquid is prepared.

### First Fusion Step

In a first fusion step, the pH of the aggregate particle dispersion liquid is increased under stirring conditions according to the aggregate particle forming step to stop the progress of aggregation, and heating is performed at a temperature equal to or higher than the melting point of the resin component to prepare a fused particle dispersion liquid.

### Fine Amorphous Resin Particle Attachment Step

In a fine amorphous resin particle attachment step, a fine amorphous resin particle dispersion liquid is added to the fused particle dispersion liquid, and the pH is decreased to attach amorphous resin particles to the surfaces of fused particles. Thus, a dispersion liquid of resin-attached particles is prepared. Here, this cover layer corresponds to a shell layer formed through a shell layer forming step described later. Note that the fine amorphous resin particle dispersion liquid can be produced in accordance with the above-described step of preparing the fine resin particle dispersion liquid.

### Second Fusion Step

In a second fusion step, the pH of the resin-attached particle dispersion liquid is increased according to the first fusion step to stop the progress of aggregation, and heating is performed at a temperature equal to or higher than the melting point of the resin component to fuse resin-attached aggregate particles, thus preparing a toner core particle dispersion liquid in which toner core particles having a shell layer are dispersed.

### Method for Producing Toner Having Cohesion Cluster

As a method for producing toner particles having a cohesion cluster that contains fine silica particles and a binder component, external addition may be performed on the toner core particles by a wet method from the viewpoint of uniformly aggregating fine silica particles and the binder component. When a toner having a cohesion cluster that contains fine silica particles and a binder component is produced by a wet method, the method may include:
(Step 1) a step of preparing a toner core particle dispersion liquid in which toner core particles are dispersed in an aqueous medium, and
(Step 2) a step of mixing fine silica particles and a polymerizable monomer (monomer) capable of producing a binder resin component with the toner core particle dispersion liquid, and subjecting the monomer to a polymerization reaction in the toner core particle dispersion liquid to form, on the toner core particles, cohesion clusters containing fine silica particles and the binder resin.

In step 1, examples of the method for preparing the toner core particle dispersion liquid include a method of using a dispersion liquid of toner core particles produced in an aqueous medium as it is, and a method of adding dry toner core particles to an aqueous medium, and mechanically dispersing the toner core particles. In the case where dry toner core particles are dispersed in an aqueous medium, a dispersing aid may be used.

The dispersing aid may be a known dispersion stabilizer, a surfactant, or the like.

Specifically, examples of the dispersion stabilizer include: inorganic dispersion stabilizers such as tricalcium phosphate, hydroxyapatite, magnesium phosphate, zinc phosphate, aluminum phosphate, calcium carbonate, magnesium carbonate, calcium hydroxide, magnesium hydroxide, aluminum hydroxide, calcium metasilicate, calcium sulfate, barium sulfate, bentonite, silica, and alumina; and organic dispersion stabilizers such as polyvinyl alcohol, gelatin, methylcellulose, methylhydroxypropylcellulose, ethylcellulose, a sodium salt of carboxymethylcellulose, and starch.

Examples of the surfactant include: anionic surfactants such as alkyl sulfate ester salt, alkylbenzene sulfonate salts, and fatty acid salts; nonionic surfactants such as polyoxyethylene alkyl ethers and polyoxypropylene alkyl ethers; and cationic surfactants such as alkylamine salts and quaternary ammonium salts.

In step 1, the solid content of the toner core particle dispersion liquid is preferably adjusted to 10% by mass or more and 50% by mass or less.

In step 2, the fine silica particles and the monomer capable of producing a binder component may be added to the toner core particle dispersion liquid as they are, or a dispersion liquid in which the fine silica particles and the monomer are dispersed in advance may be added to the toner core particle dispersion liquid. As a method of dispersing the fine silica particles and the monomer, the dispersing aids described as examples in the section of step 1 can be used. In a case where particles of a fatty acid metal salt or the like are mixed in addition to the fine silica particles, the particles are mixed in step 2 together with the fine silica particles.

Examples of the binder component include polymers obtained from monofunctional polymerizable monomers or polyfunctional polymerizable monomers, copolymers obtained by combining two or more of these, and mixtures thereof.

Examples of the polymerizable monomers include: styrene derivatives such as styrene, α-methylstyrene, β-methylstyrene, o-methylstyrene, m-methylstyrene, p-methylstyrene, 2,4-dimethylstyrene, p-n-butylstyrene, p-tert-butylstyrene, p-n-hexylstyrene, p-n-octylstyrene, p-n-nonylstyrene, p-n-decylstyrene, p-n-dodecylstyrene, p-methoxystyrene, and p-phenylstyrene; acrylic polymerizable monomers such as methyl acrylate, ethyl acrylate, n-propyl acrylate, iso-propyl acrylate, n-butyl acrylate, iso-butyl acrylate, tert-butyl acrylate, n-amyl acrylate, n-hexyl acrylate, 2-ethylhexyl acrylate, n-octyl acrylate, n-nonyl acrylate, cyclohexyl acrylate, benzyl acrylate, dimethyl phosphate ethyl acrylate, diethyl phosphate ethyl acrylate, dibutyl phosphate ethyl acrylate, and 2-benzoyloxyethyl acrylate; methacrylic polymerizable monomers such as methyl methacrylate, ethyl methacrylate, n-propyl methacrylate, iso-propyl methacrylate, n-butyl methacrylate, iso-butyl methacrylate, tert-butyl methacrylate, n-amyl methacrylate, n-hexyl methacrylate, 2-ethylhexyl methacrylate, n-octyl methacrylate, n-nonyl methacrylate, diethyl phosphate ethyl methacrylate, and dibutyl phosphate ethyl methacrylate; methylene aliphatic monocarboxylic acid esters; vinyl esters such as vinyl acetate, vinyl propionate, vinyl butyrate, vinyl benzoate, and vinyl formate; vinyl ethers such as vinyl methyl ether, vinyl ethyl ether, and vinyl isobutyl ether; vinyl ketones such as vinyl methyl ketone, vinyl hexyl ketone, and vinyl isopropyl ketone; trifunctional silane compounds having a methacryloxyalkyl group as a substituent, such as γ-methacryloxypropyltrimethoxysilane, γ-methacryloxypropyltriethoxysilane, Y-methacryloxyoctyltrimethoxysilane, γ-methacryloxypropyldiethoxymethoxysilane, and γ-methacryloxypropylethoxydimethoxysilane; and trifunctional silane compounds having an acryloxyalkyl group as a substituent, such as γ-acryloxypropyltrimethoxysilane, γ-acryloxypropyltriethoxysilane, γ-acryloxyoctyltrimethoxysilane, γ-acryloxypropyldiethoxymethoxysilane, and γ-acryloxypropylethoxydimethoxysilane.

Of these, a trifunctional silane compound can be used from the viewpoint of high affinity for silica. Such a trifunctional silane compound may be used in combination with an organosilicon compound having four reactive groups per molecule (tetrafunctional silane), an organosilicon compound having two reactive groups per molecule (bifunctional silane), or an organosilicon compound having one reactive group per molecule (monofunctional silane). Examples of the organosilicon compounds include: dimethyldiethoxysilane, tetraethoxysilane, hexamethyldisilazane, 3-aminopropyltrimethoxysilane, 3-aminopropyltriethoxysilane, 3-(2-aminoethyl)aminopropyltrimethoxysilane, 3-(2-aminoethyl)aminopropyltriethoxysilane, and trifunctional vinyl silanes such as vinyltriisocyanatosilane, vinyltrimethoxysilane, vinyltriethoxysilane, vinyldiethoxymethoxysilane, vinylethoxydimethoxysilane, vinylethoxydihydroxysilane, vinyldimethoxyhydroxysilane, vinylethoxymethoxyhydroxysilane, and vinyldiethoxyhydroxysilane.

In step 2, fine silica particles and a monomer serving as a binder component are added to and mixed with the toner core particle dispersion liquid. In this step, the temperature of the toner core particle dispersion liquid may be adjusted to a temperature suitable for a polymerization reaction in advance. Subsequently, while the toner core particles, the fine silica particles, and the monomer are mixed, a polymerization initiator is added to thereby conducting polymerization of the added monomer, so that cohesion clusters containing the fine silica particles and the binder component are externally added to the toner core particles. Thus, a dispersion liquid of toner particles is prepared.

A known polymerization initiator can be used as the polymerization initiator without particular limitation. Specific examples thereof include: peroxide polymerization initiators such as hydrogen peroxide, acetyl peroxide, cumyl peroxide, tert-butyl peroxide, propionyl peroxide, benzoyl peroxide, chlorobenzoyl peroxide, dichlorobenzoyl peroxide, bromomethyl benzoyl peroxide, lauroyl peroxide, ammonium persulfate, sodium persulfate, potassium persulfate, diisopropyl peroxycarbonate, tetralin hydroperoxide, 1-phenyl-2-methylpropyl-1-hydroperoxide, pertriphenylacetic acid-tert-hydroperoxide, tert-butyl performate, tert-butyl peracetate, tert-butyl peroxybenzoate, tert-butyl perphenylacetate, tert-butyl permethoxyacetate, per-N-(3-toluyl) palmitic acid-tert-butylbenzoyl peroxide, t-butylperoxy-2-ethylhexanoate, t-butyl peroxypivalate, t-butyl peroxyisobutyrate, t-butyl peroxyneodecanoate, methyl ethyl ketone peroxide, diisopropyl peroxycarbonate, cumene hydroperoxide, 2,4-dichlorobenzoyl peroxide, and lauroyl peroxide; and azo or diazo polymerization initiators such as 2,2′-azobis-(2,4-dimethylvaleronitrile), 2,2′-azobisisobutyronitrile, 1,1′-azobis(cyclohexane-1-carbonitrile), 2,2′-azobis-4-methoxy-2,4-dimethylvaleronitrile, and azobisisobutyronitrile.

### Filtration Step, Washing Step, Drying Step, Classification Step, and External Addition Step

Subsequently, a filtration step of filtering solid components of toner particles, and as necessary, a washing step, a drying step, and a classification step of adjusting the particle diameter are performed to produce toner particles. The toner particles may be used as a toner as they are. As necessary, the toner particles can be mixed with an external additive such as an inorganic fine powder using a mixer to cause the external additive to be attached to the toner particles, thereby producing a toner.

### Method for Measuring Physical Properties

Methods for measuring physical properties will be described below. Methods for measuring weight-average particle diameter (D4) and number-average particle diameter (D1)

The weight-average particle diameter (D4) and the number-average particle diameter (D1) of a toner are computed as described below. The measuring apparatus used is a precision particle size distribution measuring apparatus “Coulter Counter Multisizer 3” (registered trademark, manufactured by Beckman Coulter, Inc.) equipped with a 100 μm aperture tube utilizing an aperture impedance method. Accessory dedicated software “Beckman Coulter, Multisizer 3 Version 3.51” (manufactured by Beckman Coulter, Inc.) is used to set the measurement conditions and analyze measured data. The measurement is performed with the number of effective measuring channels of 25,000.

An aqueous electrolyte solution used in the measurement may be a solution prepared by dissolving special grade sodium chloride in deionized water so as to have a concentration of about 1% by mass, for example, “ISOTON II” (manufactured by Beckman Coulter, Inc.).

Before the measurement and analysis, the dedicated software was set up as described below.

On the “Change standard measurement method (SOMME)” screen of the dedicated software, the total count number in the control mode is set to 50,000 particles, the number of times of measurement is set to 1, and the Kd value is set to a value obtained by using “standard particles 10.0 μm” (manufactured by Beckman Coulter, Inc.). The “Threshold/noise level measurement button” is pushed to automatically set the threshold and the noise level. The current is set to 1,600 μA, the gain is set to 2, and the electrolyte solution is set to Isoton II. The “Flushing of aperture tube after measurement” is checked.

On the “Conversion setting of pulse into particle diameter” screen of the dedicated software, the bin interval is set to the logarithmic particle diameter, the particle diameter bin is set to a 256 particle diameter bin, and the particle diameter range is set to 2 μm to 60 μm.

A specific measurement method is as follows.
(1) A 250 mL round-bottom glass beaker dedicated for Multisizer 3 is charged with about 200 mL of the aqueous electrolyte solution and is placed on a sample stand. A stirrer rod is rotated counterclockwise at a rate of 24 revolutions/sec to perform stirring. Soiling and air bubbles in the aperture tube are removed in advance using the function of “Flushing of aperture tube” of the dedicated software.
(2) A 100 mL flat-bottom glass beaker is charged with about 30 mL of the aqueous electrolyte solution. To the aqueous electrolyte solution, about 0.3 mL of a diluted solution of a dispersant “Contaminon N” (a 10 mass % aqueous solution of a neutral detergent for cleaning precision measuring instruments, the detergent being composed of a nonionic surfactant, an anionic surfactant, and an organic builder and having a pH of 7, manufactured by FUJIFILM Wako Pure Chemical Corporation), the diluted solution being diluted about 3-fold by mass with deionized water, is added.
(3) An ultrasonic disperser “Ultrasonic Dispersion System Tetra 150” (manufactured by Nikkaki-Bios Co., Ltd.) is prepared. The ultrasonic disperser includes two oscillators with an oscillation frequency of 50 kHz in a state of a phase difference of 180 degrees, and has an electrical output of 120 W. A water tank of the ultrasonic disperser is charged with about 3.3 L of deionized water, and about 2 mL of Contaminon N is added to the water tank.
(4) The beaker in (2) above is placed in a beaker-holding hole in the ultrasonic disperser, and the ultrasonic disperser is operated. The position of the beaker in the height direction is adjusted such that the resonance of the surface of the aqueous electrolyte solution in the beaker is the highest.
(5) In a state where the aqueous electrolyte solution in the beaker in (4) above is irradiated with ultrasonic waves, about 10 mg of a toner is added little by little to the aqueous electrolyte solution and dispersed. The ultrasonic dispersion treatment is further continued for 60 seconds. During the ultrasonic dispersion, the water temperature of the water tank is controlled as appropriate in the range of 10° C. or higher and 40° C. or lower.
(6) The aqueous electrolyte solution in which the toner is dispersed and which is prepared in (5) above is added dropwise with a pipette into the round-bottom beaker prepared in (1) above and placed on the sample stand such that the measurement concentration is about 5%. The measurement is performed until the number of measured particles reaches 50,000.
(7) The measured data are analyzed using the dedicated software attached to the apparatus to compute the weight-average particle diameter (D4) and the number-average particle diameter (D1). The “Average diameter” on the “Analysis/volume statistics (arithmetic mean)” screen in the setting of graph/volume % in the dedicated software is the weight-average particle diameter (D4). The “Average diameter” on the “Analysis/number statistics (arithmetic mean)” screen in the setting of graph/number % in the dedicated software is the number-average particle diameter (D1).

### Method for Obtaining Backscattered Electron Image of Toner Surface

A base material exposure ratio of a toner is calculated using a backscattered electron image of the surface of a toner particle.

The backscattered electron image of the toner surface is obtained with a scanning electron microscope (SEM).

Backscattered electron images obtained by SEM are also called “compositional images”, in which the lower atomic number the element has, the more darkly the element is detected, and the higher atomic number the element has, the more brightly the element is detected.

In general, toner particles are resin particles mainly containing compositions that contain carbon as a main component, such as a resin component and a release agent. When fine silica particles and a metal oxide are present on the surface of a toner particle, in a backscattered electron image obtained by SEM, the fine silica particles and the meal oxide are observed as bright portions, and resin portions containing carbon as a main component are observed as dark portions.

The apparatus and observation conditions for the SEM are as follows.
Apparatus used: ULTRA PLUS, manufactured by Carl Zeiss Microscopy Company
Accelerating voltage: 1.0 kV
WD: 2.0 mm
Aperture Size: 30.0 μm
Detected signal: energy-selective backscattered electrons (EsB)
EsB Grid: 800 V
Magnification for observation: 50,000 times
Contrast: 63.0±5.0% (reference value)
Brightness: 38.0±5.0% (reference value)
Resolution: 1,024×768
Pretreatment: Toner particles are scattered on a carbon tape (no depositing).

The contrast and the brightness are appropriately set according to the conditions of the apparatus used. The accelerating voltage and the EsB Grid are set so as to achieve acquisition of structural information of the outermost surface of the toner particle, prevention of charge-up of an undeposited sample, and selective detection of high-energy backscattered electrons. The observation field of view to be selected is a portion near the apex at which the curvature of the toner particle is smallest.

Method for Checking Whether Dark Portion in Backscattered Electron Image is Derived from Carbon Atom

Whether a dark portion observed in a backscattered electron image is derived from a resin is checked by superimposing an elemental mapping image obtained by energy dispersive x-ray spectroscopy (EDS) that can be acquired using a scanning electron microscope (SEM) and the backscattered electron image.

The apparatuses and observation conditions for the SEM and EDS are as follows.
Apparatus (SEM) used: ULTRA PLUS, manufactured by Carl Zeiss Microscopy Company
Apparatus (EDS) used: NORAN System 7 and Ultra Dry EDS Detector, manufactured by Thermo Fisher Scientific Inc.
Accelerating voltage: 5.0 kV
WD: 7.0 mm
Aperture Size: 30.0 μm
Detected signal: secondary electrons (SE2)
Magnification for observation: 50,000 times
Mode: Spectral Imaging
Pretreatment: Toner particles are scattered on a carbon tape, followed by platinum sputtering.

The elemental mapping image obtained by the above method and the backscattered electron image are superimposed, and it is checked whether the carbon atom portions of the mapping image and dark portions of the backscattered electron image match.

### Method for Checking Dispersed State of Binder Component Contained in Cohesion Cluster

The dispersed state of the binder component contained in a cohesion cluster is calculated using a backscattered electron image of a cohesion cluster on a toner surface. The backscattered electron image of a cohesion cluster on a toner surface is obtained in the same manner as the method for obtaining a backscattered electron image of a toner surface.

For the obtained backscattered electron image, the dispersed state of resin particles contained in the cohesion cluster is calculated with image processing software ImageJ (developed by Wayne Rasband). The procedure is described below.

First, a backscattered electron image to be analyzed is converted to an 8-bit image using Type in the Image menu. Next, the Median diameter is set to 2.0 pixels from Filters in the Process menu to reduce image noise. An image center is estimated while an observation condition display section displayed at a lower part of the backscattered electron image is excluded, and a 1.5 μm square range is selected from the image center of the backscattered electron image with a rectangle tool (Rectangle Tool) in a toolbar.

Next, from Adjust in the Image menu, Threshold is selected. In the manual operation, all pixels corresponding to brightness B1 are selected, and Apply is clicked to obtain a binarized image. Through this operation, pixels corresponding to A1 are displayed in black (pixel group A1), and pixels corresponding to A2 are displayed in white (pixel group A2). An image center is estimated again while the observation condition display section displayed at the lower part of the backscattered electron image is excluded, and a 1.5 μm square range is selected from the image center of the backscattered electron image with the rectangle tool (Rectangle Tool) in the toolbar.

Next, a scale bar in the observation condition display section displayed at the lower part of the backscattered electron image is selected with a straight line tool (Straight Line) in the toolbar. When Set Scale in the Analyze menu is selected in this state, a new window opens, and a pixel distance of the selected straight line is entered in Distance in Pixels field.

When the value (for example, 100) of the scale bar is entered in Known Distance field of the window, the unit (for example, nm) of the scale bar is entered in Unit of Measurement field, and OK is clicked, scale setting is completed.

Subsequently, Set Measurements in the Analyze Menu is selected, and Area and Feret's diameter are checked. When Analyze Particles in the Analyze Menu is selected, Display Result is checked, and OK is clicked, domain analysis is performed.

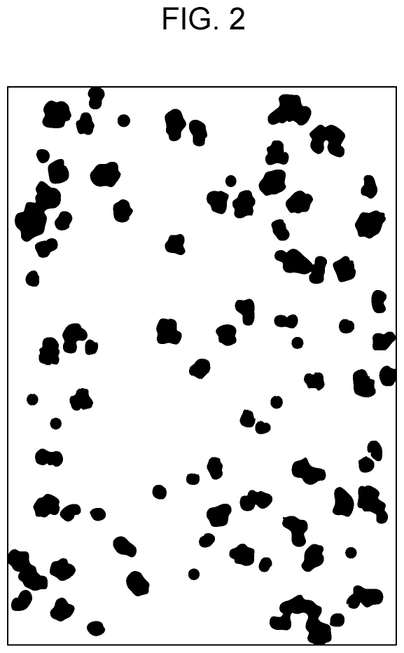

Subsequently, the obtained analyzed image is subjected to, Erode processing for 10 pixels using ImageJ and then subjected to Dilate processing for 10 pixels using ImageJ. The Erode processing and Dilate processing are performed from the item of Binary in the Process menu. FIG. 2 shows an example of an image obtained by performing the above processing.

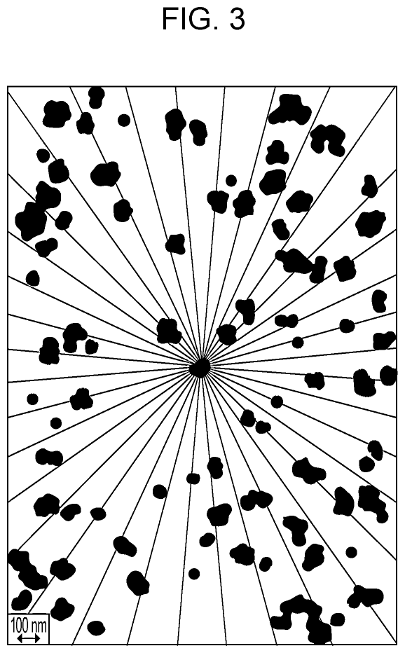

For the analyzed image obtained after the processing, the midpoint of the analyzed image is defined as a reference point, and a total of 18 straight lines are drawn with the straight line tool (Straight Line) in the toolbar at intervals of 10° from one end to the other end of the image so as to pass through the reference point. FIG. 3 shows an example of an image in which the line segments are drawn.

Subsequently, a length L of a line segment with a continuous bright portion on each of the straight lines is measured, and the number of straight lines having a line segment with a length L of 100 nm or more is counted to check whether the number of the straight lines is 12 or more in the cohesion cluster.

Method for Checking Ratio of Toner Particles Having Cohesion Cluster in which the Number of Straight Lines is 12 or More

For 30 toner particles having a cohesion cluster and included in a toner to be evaluated, the above procedure is performed on the cohesion cluster, and the number of toner particles having a cohesion cluster in which the number of the straight lines is 12 or more is counted. A ratio A of toner particles having a cohesion cluster in which the number of the straight lines is 12 or more is calculated by the following formula.

A={(the number of toner particles having cohesion cluster in which the number of the straight lines is 12 or more)/30}

### Method for Checking Area Fraction of Binder Component Contained in Cohesion Cluster

The area fraction of the binder component is calculated based on a domain D1 derived from the binder component and a domain D2 derived from a component other than the binder component using a backscattered electron image of a cohesion cluster on the toner surface. The backscattered electron image of the cohesion cluster on the toner surface is obtained in the same manner as the method for obtaining a backscattered electron image of a toner surface.

The analysis of the domains D1 and D2 is conducted using a backscattered electron image of the outermost surface of a toner particle obtained by the above method with image processing software ImageJ (developed by Wayne Rasband). The procedure is described below.

First, a backscattered electron image to be analyzed is converted to an 8-bit image using Type in the Image menu. Next, the Median diameter is set to 2.0 pixels from Filters in the Process menu to reduce image noise. An image center is estimated while an observation condition display section displayed at a lower part of the backscattered electron image is excluded, and a 1.5 μm square range is selected from the image center of the backscattered electron image with a rectangle tool (Rectangle Tool) in a toolbar.

Next, using the function of Freehand selections in the Image menu, only portions where carbon atom portions of the mapping image and dark portions of the backscattered electron image match are selected, and all the selected portions are filled with black. Furthermore, all portions are filled with white except for the above portions where carbon atom portions of the mapping image and dark portions of the backscattered electron image match. Next, from Adjust, Threshold is selected. In the manual operation, 128, which is the middle tone between black and white in the 8-bit image, is selected as a threshold, and Apply is clicked to obtain a binarized image.

Through this operation, pixels corresponding to the domain D1 (binder component) are displayed in black (pixel group A1), and pixels corresponding to the domain D2 (other than binder component) are displayed in white (pixel group A2).

An image center is estimated again while the observation condition display section displayed at the lower part of the backscattered electron image is excluded, and a 1.5 μm square range is selected from the image center of the backscattered electron image with the rectangle tool (Rectangle Tool) in the toolbar.

Next, a scale bar in the observation condition display section displayed at the lower part of the backscattered electron image is selected with a straight line tool (Straight Line) in the toolbar. When Set Scale in the Analyze menu is selected in this state, a new window opens, and a pixel distance of the selected straight line is entered in Distance in Pixels field.

When the value (for example, 100) of the scale bar is entered in Known Distance field of the window, the unit (for example, nm) of the scale bar is entered in Unit of Measurement field, and OK is clicked, scale setting is completed.

Subsequently, Set Measurements in the Analyze Menu is selected, and Area and Feret's diameter are checked. When Analyze Particles in the Analyze Menu is selected, Display Result is checked, and OK is clicked, domain analysis is performed.

From newly opened Results window, the area (Area) for each domain corresponding to the domain D1 formed by the pixel group A1 and the domain D2 formed by the pixel group A2 is acquired.

The sum of the obtained areas of the domain D1 derived from the binder component is denoted by S1 (μm²), and the sum of the obtained areas of the domain D2 derived from a component other than the binder component is denoted by S2 (μm²). A binder component area fraction S is calculated from S1 an S2 obtained above using the following formula.

$$S ( area \% ) = \{ S 1 / ( S 1 + S 2 ) \} \times 100$$

The above procedure is performed for 10 fields of view per toner particle to be evaluated, and the arithmetic mean value is used as the binder component area fraction. Method for checking area fraction of fatty acid metal salt contained in cohesion cluster

The area fraction of the fatty acid metal salt is basically checked by the same method as that for the area fraction of the binder component. Specifically, the area fraction of the fatty acid metal salt is calculated based on a domain D3 derived from a fatty acid metal salt component and a domain D4 derived from a component other than the fatty acid metal salt component using a backscattered electron image of a cohesion cluster on the toner surface. The backscattered electron image of the cohesion cluster on the toner surface is obtained in the same manner as the method for obtaining a backscattered electron image of a toner surface.

The analysis of the domains D3 and D4 is conducted using a backscattered electron image of the outermost surface of a toner particle obtained by the above method with image processing software ImageJ (developed by Wayne Rasband).

The analysis is the same as that in the case of the area fraction of the binder resin, but the method of selecting D3 is performed as follows. Using the function of Freehand selections in the Image menu, only portions are selected in which portions where zinc, calcium, magnesium, or aluminum is present in the elemental mapping image match portions with intermediate contrast between bright portions of silica and dark portions of the binder resin of the backscattered electron image. All the selected portions are filled with black. Furthermore, all portions are filled with white except for the above portions in which portions where zinc, calcium, magnesium, or aluminum is present in the elemental mapping image match portions with intermediate contrast between bright portions of silica and dark portions of the binder resin of the backscattered electron image. Next, from Adjust, Threshold is selected. In the manual operation, 128, which is the middle tone between black and white in the 8-bit image, is selected as a threshold, and Apply is clicked to obtain a binarized image.

Through this operation, pixels corresponding to the domain D3 (fatty acid metal salt component) are displayed in black (pixel group A3), and pixels corresponding to the domain D4 (other than fatty acid metal salt component) are displayed in white (pixel group A4).

An image center is estimated again while the observation condition display section displayed at the lower part of the backscattered electron image is excluded, and a 1.5 μm square range is selected from the image center of the backscattered electron image with the rectangle tool (Rectangle Tool) in the toolbar.

Next, a scale bar in the observation condition display section displayed at the lower part of the backscattered electron image is selected with a straight line tool (Straight Line) in the toolbar. When Set Scale in the Analyze menu is selected in this state, a new window opens, and a pixel distance of the selected straight line is entered in Distance in Pixels field.

When the value (for example, 100) of the scale bar is entered in Known Distance field of the window, the unit (for example, nm) of the scale bar is entered in Unit of Measurement field, and OK is clicked, scale setting is completed.

Subsequently, Set Measurements in the Analyze Menu is selected, and Area and Feret's diameter are checked. When Analyze Particles in the Analyze Menu is selected, Display Result is checked, and OK is clicked, domain analysis is performed.

From newly opened Results window, the area (Area) for each domain corresponding to the domain D3 formed by the pixel group A3 and the domain D4 formed by the pixel group A4 is acquired.

The sum of the obtained areas of the domain D3 derived from the fatty acid metal salt component is denoted by S3 (μm²), and the sum of the obtained areas of the domain D4 derived from a component other than the fatty acid metal salt component is denoted by S4 (μm²). A fatty acid metal salt component area fraction S is calculated from S3 an S4 obtained above using the following formula.

$$S ( area \% ) = \{ S 3 / ( S 3 + S 4 ) \} \times 100$$

The above procedure is performed for 10 fields of view per toner particle to be evaluated, and the arithmetic mean value is used as the fatty acid metal salt component area fraction.

### Method of Observing Toner and Method of Calculating the Number of Toner Particles

The toner is observed with a scanning electron microscope (SEM).

The apparatus and observation conditions for the SEM are as follows.
Apparatus used: ULTRA PLUS, manufactured by Carl Zeiss Microscopy Company
Accelerating voltage: 1.0 kV
WD: 2.0 mm
Aperture Size: 30.0 μm
Detected signal: secondary electrons (SE2)
Magnification for observation: 2,000 times
Contrast: 45.0±5.0% (reference value)
Brightness: 38.0±5.0% (reference value)
Resolution: 1,024×768
Pretreatment: Toner particles are scattered on a carbon tape (no depositing).

The contrast and the brightness are appropriately set according to the conditions of the apparatus used. The accelerating voltage is set so as to achieve acquisition of structural information of the outermost surface of the toner particle and prevention of charge-up of an undeposited sample.

As for the number of observation fields of view, the number of toner particles, the entirety of each of the toner particles being located within the observation field of view in the obtained secondary electron image, is counted, and when the number of toner particles is represented by Tₐₗₗ (particles), the observation is continued up to the number of fields of view at which Tₐₗₗ is 300 or more.

### Method of Calculating Number Percentage CI of Toner Particles Having Cohesion Cluster

In the secondary electron images of all the fields of view obtained in the above observation, among toner particles, the entirety of each of the toner particles being located within the observation field of view, the number of toner particles having a cohesion cluster is counted and expressed as T_{agg} (particles). As for the toner having a cohesion cluster, the number of toner particles as shown in FIG. 1 is counted.

CI (number %) is calculated from Tₐₗₗ (particles) and T_{agg} (particles) determined above using the following formula.

$$CI ( number \% ) = {T}_{agg} / {T}_{all} \times 100$$

### Method of Measuring Size of Cohesion Cluster and Method of Counting the Number of Toner Particles Having Cohesion Cluster

In the above-described scanning electron microscopy, a photograph of the entirety of the toner is taken at an appropriate magnification (5k to 10k) and saved. The image resolution is set to 1,024×768 pixels.

From the obtained SEM image, a portion determined to be a cohesion cluster is selected on the image using image analysis software ImageJ (developed by Wayne Rasband). The size of the cohesion cluster is defined by the maximum Feret diameter in this selected region. The procedure of the calculation is described below.
(a) In [Analyze]-[Set Scale], scale setting is performed.
(b) [Analyze]-[Set Measurements]-[Feret's diameter] is checked.
(c) [Freehand Selections] is selected, and a cohesion cluster on the image is selected by hand.
(d) [Analyze]-[Measure] is selected, and the maximum Feret diameter (Feret) in the selected portion is obtained.
(e) When a plurality of cohesion clusters are present on the image, (c) and (d) are repeated.
(f) For the remaining nine images in the observation of the toner having a cohesion cluster with a maximum Feret diameter of 500 nm or more and 8,000 nm or less, a similar analysis is performed.
(g) The maximum value of Feret (Feret diameter) of the obtained analysis results is determined as the maximum Feret diameter.

Portions having a maximum Feret diameter of 500 nm or more and 8,000 nm or less are determined as cohesion clusters.

The toner is arbitrarily observed with the scanning electron microscope, and the arithmetic mean value of the maximum Feret diameters of a total of 100 cohesion clusters is defined as Ag.

Among toner particles that are arbitrarily observed, number % of toner particles having a cohesion cluster is defined as CI.

Method for evaluating whether fine silica particles and binder component are contained in cohesion cluster

Whether fine silica particles and a binder component are contained in a cohesion cluster is checked using STEM-EDX and a scanning electron microscope.

First, for a toner having a cohesion cluster, the sectional structure and the composition of the cohesion cluster are evaluated using STEM-EDX.

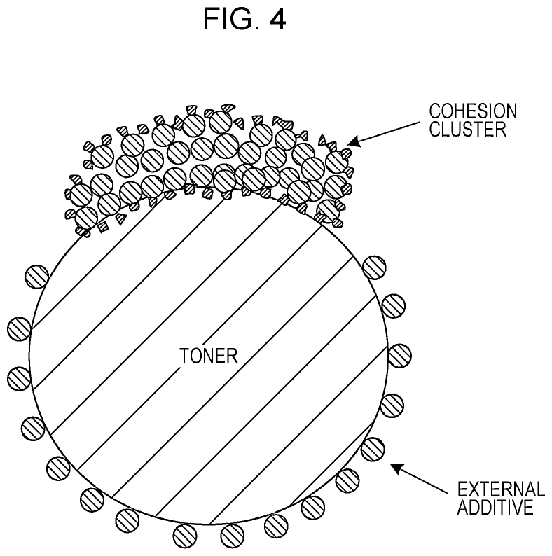

An Os film (5 nm) and a naphthalene film (20 nm) are formed on the toner as protective films with an osmium plasma coater (Filgen, Inc., OPC80T), and the resulting toner is embedded in a photocurable resin D800 (JEOL Ltd.). Subsequently, a toner-particle section with a film thickness of 100 nm is prepared with an ultrasonic ultramicrotome (Leica microsystems, UC7) at a cutting speed of 1 mm/s. In this case, a plurality of toner particles may be processed at one time to prepare a section of 300 to 500 particles of the toner. FIG. 4 illustrates a schematic view of a section of a toner having a cohesion cluster.

For the prepared section, STEM-EDX observation is performed using the STEM function of TEM-EDX (TEM: JEOL Ltd., JEM-2800 (200 keV), EDX detector: JEOL Ltd., Dry SD 100 GV, EDX system: Thermo Fisher Scientific Inc., NORAN SYSTEM 7). Adjustment is performed such that the probe size of STEM is 1.0 nm, the magnification for observation is 50k to 300k, the image size of EDX is 256×256 pixels, and the save rate is 10,000 cps, and an image is acquired by integrating 50 frames. The field of view of the observation position is set such that a cohesion cluster present on an outer peripheral portion of a toner particle is included.

Whether particles containing silica as a main component and a binder component are present in the cohesion cluster can be determined by checking whether portions where silicon and oxygen are observed in large amounts and portions where an element derived from the binder component is observed in a large amount are separately present at the same position. When a resin is used as the binder component, carbon is observed in a large amount.

Next, for the toner having a cohesion cluster, a backscattered electron image is observed using a scanning electron microscope. The image capturing conditions are as follows.

### (1) Preparation of Sample

A carbon tape is attached to a sample stage (aluminum sample stage: 12.5 mmφ×6 mmt), and a toner is placed thereon. Furthermore, air is blown to remove the excess sample from the sample stage. The sample stage is placed in a sample holder and placed in a scanning electron microscope (Zeiss Company, Ultra Plus).

### (2) Setting of Electron Microscope Observation Conditions

Whether a cohesion cluster containing fine silica particles and a binder component is present is checked using an image obtained by backscattered electron image observation with Ultra Plus. In a backscattered electron image, since the image contrast changes depending on the elemental composition, the presence of silica and the binder component in the cohesion cluster can be determined. The accelerating voltage is set to 0.7 kV, ECB Grid is set to 500 V, and WD is set to 3.0 mm.

### (3) Focal Point Adjustment

The magnification for observation is set to 30,000 (30k) times, and Alignment and Stigma are adjusted. Next, the field of view is adjusted to an area having a form considered to be a cohesion cluster at an appropriate magnification for observation. By confirming that two types of contrast, namely, contrast considered to correspond to silica and contrast considered to correspond to a binder component are present based on the obtained backscattered electron image, it can be determined that the area is identical to the cohesion cluster that has been subjected to the composition observation by STEM-EDX.

Method of Calculating Number Percentage Ca or Cb of Toner Particles Having Cohesion Cluster when Ultrasonic Wave Treatment is Performed

A glass container is charged with about 10 mL of deionized water from which impurity solids and the like have been removed in advance.

To the deionized water, about 0.5 mL of a diluted solution of a dispersant “Contaminon N” (a 10 mass % aqueous solution of a neutral detergent for cleaning precision measuring instruments, the detergent being composed of a nonionic surfactant, an anionic surfactant, and an organic builder and having a pH of 7, manufactured by FUJIFILM Wako Pure Chemical Corporation), the diluted solution being diluted about 3-fold by mass with deionized water, is added. About 0.02 g of a measurement sample is further added, and the following dispersion treatment is performed under stirring using an ultrasonic disperser to prepare a dispersion liquid for measurement. At that time, cooling is performed as appropriate such that the temperature of the dispersion liquid is 10° C. or higher and 40° C. or lower. An ultrasonic homogenizer (“VP-050” (manufactured by TAITEC CORPORATION)) with an oscillation frequency of 30 kHz is used as the ultrasonic disperser. An oscillation portion is caused to enter the dispersion liquid by 1.0 cm, and oscillation is performed under the ultrasonic wave condition A or the ultrasonic wave condition B below.
Ultrasonic wave condition A: output frequency 30 kHz, output capacity 0.75 W, and irradiation time 300 s
Ultrasonic wave condition B: output frequency 30 kHz, output capacity 25 W, and irradiation time 300 s

The dispersion liquid obtained by the above procedure is filtered through Kiriyama filter paper (No. 5C: pore size 1 μm) to separate particles and the filtrate. The obtained particles are further washed with 100 parts by mass of deionized water and subjected to vacuum drying at 25° C. for 24 hours to prepare a powder for measuring the number percentage Ca or Cb of toner particles having a cohesion cluster.

For the obtained powder, Ca and Cb are calculated by the same procedure as the “method of calculating number percentage CI of toner particles having cohesion cluster”, and whether the relationships of formulae (1) and (2) below are satisfied is checked.

$$0.9 \leq Ca / CI \leq 1. \qquad Formula ( 1 )$$

$$0.1 \leq Cb / CI \leq 0.4 \qquad Formula ( 2 )$$

### Method for Identifying Fatty Acid Metal Salt

(1) Method for Isolating Fatty Acid Metal Salt Particles from Toner

If necessary, a fatty acid metal salt can be isolated from a toner by the following method.

To 100 mL of deionized water, 160 g of sucrose (manufactured by Kishida Chemical Co., Ltd.) is added and dissolved on a hot water bath to prepare a concentrated sucrose solution. Into a tube (volume: 50 mL) for centrifugal separation, 6 mL of Contaminon N (a 10 mass % aqueous solution of a neutral detergent for cleaning precision measuring instruments, the detergent being composed of a nonionic surfactant, an anionic surfactant, and an organic builder and having a pH of 7, manufactured by FUJIFILM Wako Pure Chemical Corporation) is placed. To this tube, 1.0 g of a toner is added, and agglomerates of the toner are loosened with a spatula or the like.

An ultrasonic homogenizer (“VP-050” (manufactured by TAITEC CORPORATION)) with an oscillation frequency of 30 kHz is used, and an oscillation portion is caused to enter the toner dispersion liquid by 1.0 cm, and oscillation is performed under the ultrasonic wave condition B below.
Ultrasonic wave condition B: output frequency 30 kHz, output capacity 25 W, and irradiation time 300 s

To the tube for centrifugal separation, 31 g of the concentrated sucrose solution is added, and the tube is shaken in a shaker (AS-IN, sold by As One Corporation) at 300 strokes per minute (spm) for 20 minutes. After shaking, the resulting solution is transferred to a glass tube (50 mL) for a swing rotor and is centrifuged in a centrifugal separator (H-9R, manufactured by Kokusan Co., Ltd.) at 3,500 rpm for 30 minutes.

Sufficient separation of toner particles from an aqueous solution through this operation is visually confirmed, and the toner particles that have separated to form the top layer are then collected with a spatula or the like. Thus, the toner particles are separated from the dispersion liquid.

Subsequently, the dispersion liquid after the toner particles are collected is again centrifuged, and a dispersion liquid containing a fatty acid metal salt that has separated to form the top layer is collected.

The above operation is repeated to collect a dispersion liquid containing the fatty acid metal salt, and centrifugal separation is then performed again to provide a concentrated liquid of the fatty acid metal salt with an increased concentration.

The concentrated liquid is air-dried for one day, and then dried in a dryer at 40° C. for eight hours or more to provide a measurement sample. This operation is performed a plurality of times to prepare a required amount of isolated fatty acid metal salt particles.

### (2) Identification of Central Metal by X-Ray Fluorescence

X-ray fluorescence spectroscopy is performed using the isolated fatty acid metal salt particles to perform composition analysis, thereby identifying the metal element of the fatty acid metal salt particles.

### (3) Identification of Fatty Acid of Fatty Acid Metal Salt by Pyrolysis GCMS

Specific conditions for identifying the fatty acid by pyrolysis GCMS are described below.
Mass spectrometer: ISQ, Thermo Fisher Scientific Inc.
GC apparatus: Focus GC, Thermo Fisher Scientific Inc.
Ion source temperature: 250° C.
Ionization method: EI
Mass range: 50 to 1,000 m/z
Column: HP-5 MS [30 m]
Pyrolyzer: JPS-700, manufactured by Japan Analytical Industry Co., Ltd.

To a pyrofoil at 590° C., the fatty acid metal salt separated by the isolation operation and 1 μL of tetramethylammonium hydroxide (TMAH) are added. The sample prepared above is subjected to pyrolysis GCMS analysis under the above conditions to provide peaks derived from the fatty acid metal salt. Due to the action of TMAH serving as a methylating agent, the fatty acid component is detected as a methylated product. The peaks are analyzed to identify the fatty acid structure of the fatty acid metal salt.

### EXAMPLES

The present disclosure will be specifically described by way of production examples and Examples. However, these examples do not limit the present disclosure in any way. In the following production examples and Examples, the unit “part” is on a mass basis unless otherwise specified.

Production examples of toner particles will be described.

### Preparation of Resin Particle Dispersion Liquid 1

First, 78.0 parts of styrene, 20.7 parts of butyl acrylate, 1.3 parts of acrylic acid serving as a monomer that provides a carboxyl group, and 3.2 parts of n-lauryl mercaptan were mixed together to prepare a solution. To the solution, the whole amount of aqueous solution prepared by dissolving 2.0 parts of a linear sodium alkylbenzene sulfonate (product name: Neogen RK (manufactured by DKS Co. Ltd.) in 150 parts of deionized water was added and dispersed.

An aqueous solution of 0.3 parts of potassium persulfate in 10 parts of deionized water was added to the resulting mixture while the mixture was further slowly stirred for 10 minutes. After the system was purged with nitrogen, the mixture was subjected to emulsion polymerization at 70° C. for six hours. After completion of the polymerization, the reaction mixture was cooled to room temperature, and deionized water was added thereto. Thus, a resin particle dispersion liquid 1 having a solid content of 12.5% by mass and a median diameter of 0.2 μm on a volume basis was prepared.

### Preparation of Release Agent Dispersion Liquid 1

First, 100 parts of a release agent (behenyl behenate, melting point: 72.1° C.) and 15 parts of an aliphatic alcohol alkylene oxide adduct were mixed with 385 parts of deionized water. The mixture was dispersed for about one hour with a wet jet mill JN 100 (manufactured by JOKOH CO., LTD.) to prepare a release agent dispersion liquid 1. The concentration of the release agent dispersion liquid 1 was 20% by mass.

### Preparation of Coloring Agent Dispersion Liquid 1

First, 100 parts of carbon black “Nipex 35, (manufactured by Orion Engineered Carbons)” serving as a coloring agent and 15 parts of an aliphatic alcohol alkylene oxide adduct were mixed with 885 parts of deionized water. The mixture was dispersed for about one hour with a wet jet mill JN 100 to prepare a coloring agent dispersion liquid 1.

### Preparation Example of Toner Core Particle Dispersion Liquid 1

### Dispersion Step

First, 265 parts of the resin particle dispersion liquid 1, 10 parts of the release agent dispersion liquid 1, 10 parts of the coloring agent dispersion liquid 1, 2.9 parts of an aliphatic alcohol alkylene oxide adduct, and 0.6 parts of a linear sodium alkylbenzene sulfonate (Neogen RK) were dispersed with a homogenizer (ULTRA-TURRAX T50, manufactured by IKA). The temperature in the vessel was adjusted to 30° C. under stirring, and a 1 mol/L aqueous sodium hydroxide solution was added to the mixture to adjust the pH to 8.0.

### Aggregation Step

An aqueous solution prepared by dissolving 0.08 parts of aluminum chloride serving as an aggregating agent in 10 parts of deionized water was added to the mixture over a period of 10 minutes at 30° C. under stirring. After the resulting mixture was left to stand for three minutes, a temperature rise was started. The mixture was heated to 50° C. to form associated particles. In that state, the particle diameter of the associated particles was measured with a “Multisizer 3 Coulter Counter” (registered trademark, manufactured by Beckman Coulter, Inc.). When the weight-average particle diameter was 7.0 μm, 0.9 parts of sodium chloride and 5.0 parts of an aliphatic alcohol were added thereto to terminate the particle growth.

A 1 mol/L aqueous sodium hydroxide solution was added to the mixture to adjust the pH to 9.0, and the mixture was then heated to 95° C. to spheroidize aggregate particles. When the average circularity reached 0.980, a temperature drop was started. The mixture was cooled to room temperature to prepare a toner core particle dispersion liquid 1.

### Preparation Example of Monomer Dispersion Liquid 1 Having Fine Silica Particles, Binder Component, and Fatty Acid Metal Salt Particles

First, 100 parts of styrene, 20 parts of methacryloxypropyltrimethoxysilane, 70 parts of colloidal silica, and 30 parts of zinc stearate were dispersed with a homogenizer (ULTRA-TURRAX T50, manufactured by IKA). The temperature in the vessel was adjusted to 25° C., and stirring was performed for one hour to prepare a monomer dispersion liquid 1 having fine silica particles, a binder component, and fatty acid metal salt particles.

### Preparation Examples of Monomer Dispersion Liquids 2 to 15 Having Fine Silica Particles, Binder Component, and Fatty Acid Metal Salt Particles

Monomer dispersion liquids 2 to 15 were prepared as in the preparation of the monomer dispersion liquid 1 except that the amounts (parts) and the types of materials were changed as described in Table 1.

### Production Example of Fine Silicone Resin Particles

In a reaction vessel equipped with a thermometer and a stirrer, 360.0 parts of water was put, and 15.0 parts of hydrochloric acid with a concentration of 5.0% by mass was added thereto to provide a homogenous solution. While the solution was stirred at a temperature of 25° C., 136.0 parts of methyltrimethoxysilane was added thereto, and the resulting mixture was stirred for five hours and then filtered to provide a clear reaction mixture containing a silanol compound or a partial condensate thereof.

In a reaction vessel equipped with a thermometer, a stirrer, and a dropping device, 440.0 parts of water was put, and 17.0 parts of an aqueous ammonia with a concentration of 10.0% by mass was added thereto to provide a homogeneous solution. While the solution was stirred at a temperature of 35° C., 100 parts of the reaction mixture obtained in the above step was added dropwise over a period of 0.5 hours, and stirring was performed for six hours to provide a suspension. The resulting suspension was centrifuged to settle fine particles. The fine particles were collected and dried in a dryer at a temperature of 200° C. for 24 hours to obtain fine silicone resin particles.

The number-average particle diameter of primary particles of the obtained fine silicone resin particles was found to be 100 nm with a transmission scanning electron microscope.

TABLE 1

| | | | Binder component | | |
|---|---|---|---|---|---|
| | | Amount | | Amount | |
| Monomer | | added in | | added in | |
| dispersion | | dispersion | | dispersion | |
| liquid | Monomer | step | | step | Fine silica particle |
| No. | A | [parts] | Monomer B | [parts] | Type |
| 1 | Styrene | 100 | Methacryloxypropyltrimethoxysilane | 20 | Colloidal silica |
| 2 | Styrene | 100 | Methacryloxypropyltrimethoxysilane | 10 | Colloidal silica |
| 3 | Styrene | 100 | Methacryloxypropyltrimethoxysilane | 30 | Colloidal silica |
| 4 | Styrene | 100 | Methacryloxypropyltrimethoxysilane | 20 | Fumed silica |
| 5 | Styrene | 100 | Methacryloxypropyltriethoxysilane | 20 | Colloidal silica |
| 6 | Styrene | 40 | — | — | Colloidal silica |
| 7 | Styrene | 100 | Methacryloxypropyltrimethoxysilane | 20 | Colloidal silica |
| 8 | Styrene | 80 | Methacryloxypropyltriethoxysilane | 20 | Colloidal silica |
| 9 | Styrene | 100 | Methacryloxypropyltrimethoxysilane | 20 | Colloidal silica |
| 10 | Styrene | 40 | Methacryloxypropyltrimethoxysilane | 10 | Colloidal silica |
| 11 | Styrene | 40 | — | — | Colloidal silica |
| 12 | — | — | — | — | Colloidal silica |
| 13 | Styrene | 120 | — | — | Colloidal silica |
| 14 | Styrene | 100 | Methacryloxypropyltrimethoxysilane | 40 | Colloidal silica |
| 15 | Styrene | 100 | Methacryloxypropyltrimethoxysilane | 20 | Fumed silica |

| | Fine silica particle | | Fatty acid metal salt | | |
|---|---|---|---|---|---|
| | | Amount | | | Amount |
| Monomer | | added in | | | added in |
| dispersion | Particle | dispersion | | Particle | dispersion |
| liquid | diameter | step | | diameter | step |
| No. | [nm] | [parts] | Type | [nm] | [parts] |
| 1 | 105 | 70 | Zinc stearate | 580 | 30 |
| 2 | 105 | 70 | Zinc stearate | 580 | 30 |
| 3 | 105 | 70 | Zine stearate | 580 | 30 |
| 4 | 35 | 70 | Zinc stearate | 580 | 30 |
| 5 | 105 | 60 | Zinc stearate | 580 | 15 |
| 6 | 105 | 95 | Zinc stearate | 580 | 30 |
| 7 | 105 | 92.5 | Zinc stearate | 580 | 7.5 |
| 8 | 105 | 50 | Zinc stearate | 580 | 50 |
| 9 | 105 | 100 | — | — | — |
| 10 | 105 | 50 | Zinc stearate | 580 | 50 |
| 11 | 105 | 90 | Zinc stearate | 580 | 30 |
| 12 | 105 | 100 | — | — | — |
| 13 | 105 | 70 | Zinc stearate | 580 | 30 |
| 14 | 105 | 70 | Zinc stearate | 580 | 30 |
| 15 | 15 | 70 | Zinc stearate | 580 | 30 |

Next, production examples of a toner will be described.

### Production Example of Toner 1

To 100 parts of the toner core particle dispersion liquid 1, 2.75 parts of the monomer dispersion liquid 1 prepared by the method described above and 0.005 parts of potassium persulfate were added, the temperature in a vessel was adjusted to 90° C., and the mixture was stirred with a Fullzone impeller for two hours to prepare a toner-particle dispersion liquid 1.

Hydrochloric acid was added to the toner-particle dispersion liquid 1 to adjust the pH to 1.5 or less. The mixture was stirred for one hour, left to stand, and then subjected to solid-liquid separation with a pressure filter to prepare a toner cake. The toner cake was reslurried with deionized water to provide a dispersion liquid again, and the dispersion liquid was then subjected to solid-liquid separation with the above filter. After the reslurrying and the solid-liquid separation were repeated until the filtrate had an electrical conductivity of 5.0 μS/cm or less, final solid-liquid separation was performed to prepare a toner cake. The resulting toner cake was dried and further classified with a classifier to prepare toner particles 1. The toner particles 1 had a weight-average particle diameter of 6.9 μm.

Next, 100 parts of the toner particles 1 and 0.4 parts of fine silicone resin particles were put into an FM mixer (Model FM10C, manufactured by Nippon Coke & Engineering Co., Ltd.) in which water at 7° C. was passed through a jacket.

After the water temperature in the jacket was stabilized at 7° C.±1° C., mixing was performed at a peripheral speed of a rotation impeller of 38 m/sec for five minutes to prepare a toner mixture 1. At this time, the water flow rate in the jacket was appropriately adjusted such that the temperature in the vessel of the FM mixer did not exceed 25° C. The resulting toner mixture 1 was sieved through a mesh with a sieve opening of 75 μm to obtain a toner 1. Physical properties of the obtained toner 1 are shown in Tables 3-1 and 3-2.

### Production Examples of Toners 2 to 6, 8 to 23, and 25

Toners 2 to 6, 8 to 23, and 25 were obtained as in the production example of the toner 1 except that the amounts (parts), the type of materials, and production conditions were changed as described in Table 2. Physical properties of the obtained toners 2 to 6, 8 to 23, and 25 are shown in Tables 3-1 and 3-2.

### Production Example of Toner 7

To 100 parts of the toner core particle dispersion liquid 1, 0.6 parts of the monomer dispersion liquid 2 prepared by the method described above and 0.001 parts of potassium persulfate were added, the temperature in a vessel was adjusted to 90° C., the mixture was then dispersed with a homogenizer (ULTRA-TURRAX T50, manufactured by IKA) for 10 minutes and stirred with a Fullzone impeller for two hours to prepare a toner-particle dispersion liquid 7.

Hydrochloric acid was added to the toner-particle dispersion liquid 7 to adjust the pH to 1.5 or less. The mixture was stirred for one hour, left to stand, and then subjected to solid-liquid separation with a pressure filter to prepare a toner cake. The toner cake was reslurried with deionized water to provide a dispersion liquid again, and the dispersion liquid was then subjected to solid-liquid separation with the above filter. After the reslurrying and the solid-liquid separation were repeated until the filtrate had an electrical conductivity of 5.0 μS/cm or less, final solid-liquid separation was performed to prepare a toner cake. The resulting toner cake was dried and further classified with a classifier to prepare toner particles 7. The toner particles 7 had a weight-average particle diameter of 6.9 μm.

Next, 100 parts of the toner particles 7 and 0.4 parts of fine silicone resin particles were put into an FM mixer (Model FM10C, manufactured by Nippon Coke & Engineering Co., Ltd.) in which water at 7° C. was passed through a jacket.

After the water temperature in the jacket was stabilized at 7° C.±1° C., mixing was performed at a peripheral speed of a rotation impeller of 38 m/sec for five minutes to prepare a toner mixture 7. At this time, the water flow rate in the jacket was appropriately adjusted such that the temperature in the vessel of the FM mixer did not exceed 25° C. The resulting toner mixture 7 was sieved through a mesh with a sieve opening of 75 μm to obtain a toner 7. Physical properties of the obtained toner 7 are shown in Tables 3-1 and 3-2.

### Production Example of Toner 24

To 100 parts of the toner core particle dispersion liquid 1, 0.6 parts of the monomer dispersion liquid 2 prepared by the method described above and 0.001 parts of potassium persulfate were added, the temperature in a vessel was adjusted to 90° C., the mixture was then dispersed with a homogenizer (ULTRA-TURRAX T50, manufactured by IKA) for 30 minutes and then stirred with a Fullzone impeller for two hours to prepare a toner-particle dispersion liquid 24.

Hydrochloric acid was added to the toner-particle dispersion liquid 24 to adjust the pH to 1.5 or less. The mixture was stirred for one hour, left to stand, and then subjected to solid-liquid separation with a pressure filter to prepare a toner cake. The toner cake was reslurried with deionized water to provide a dispersion liquid again, and the dispersion liquid was then subjected to solid-liquid separation with the above filter. After the reslurrying and the solid-liquid separation were repeated until the filtrate had an electrical conductivity of 5.0 μS/cm or less, final solid-liquid separation was performed to prepare a toner cake. The resulting toner cake was dried and further classified with a classifier to prepare toner particles 24. The toner particles 24 had a weight-average particle diameter of 6.9 μm.

Next, 100 parts of the toner particles 24 and 0.4 parts of fine silicone resin particles were put into an FM mixer (Model FM10C, manufactured by Nippon Coke & Engineering Co., Ltd.) in which water at 7° C. was passed through a jacket. After the water temperature in the jacket was stabilized at 7° C.±1° C., mixing was performed at a peripheral speed of a rotation impeller of 38 m/see for five minutes to prepare a toner mixture 24. At this time, the water flow rate in the jacket was appropriately adjusted such that the temperature in the vessel of the FM mixer did not exceed 25° C. The resulting toner mixture 24 was sieved through a mesh with a sieve opening of 75 μm to obtain a toner 24. Physical properties of the obtained toner 24 are shown in Tables 3-1 and 3-2.

TABLE 2

| | | Monomer dispersion liquid having | | | | |
|---|---|---|---|---|---|---|
| | Toner core | silica and binder component | | Additive | | |
| | particles | | Amount | | Amount | |
| Toner | No. | No. | [parts] | Type | [parts] | Stirring conditions |
| 1 | 1 | 1 | 2.75 | Potassium persulfate | 0.005 | Fullzone impeller alone |
| 2 | 1 | 1 | 0.50 | Potassium persulfate | 0.001 | Fullzone impeller alone |
| 3 | 1 | 1 | 6.50 | Potassium persulfate | 0.012 | Fullzone impeller alone |
| 4 | 1 | 2 | 2.75 | Potassium persulfate | 0.004 | Fullzone impeller alone |
| 5 | 1 | 3 | 2.75 | Potassium persulfate | 0.006 | Fullzone impeller alone |
| 6 | 1 | 4 | 5.00 | Potassium persulfate | 0.012 | Fullzone impeller alone |
| 7 | 1 | 2 | 0.60 | Potassium persulfate | 0.001 | Combined use of Fullzone |
| | | | | | | impeller and homogenizer |
| 8 | 1 | 5 | 2.75 | Potassium persulfate | 0.005 | Fullzone impeller alone |
| 9 | 1 | 6 | 2.00 | Potassium persulfate | 0.004 | Fullzone impeller alone |
| 10 | 1 | 7 | 2.75 | Potassium persulfate | 0.005 | Fullzone impeller alone |
| 11 | 1 | 8 | 4.15 | Potassium persulfate | 0.012 | Fullzone impeller alone |
| 12 | 1 | 3 | 2.00 | Potassium persulfate | 0.006 | Fullzone impeller alone |
| 13 | 1 | 2 | 4.00 | Potassium persulfate | 0.004 | Fullzone impeller alone |
| 14 | 1 | 9 | 2.75 | Potassium persulfate | 0.005 | Fullzone impeller alone |
| 15 | 1 | 10 | 2.75 | Potassium persulfate | 0.005 | Fullzone impeller alone |
| 16 | 1 | 1 | 2.75 | Potassium persulfate | 0.005 | Fullzone impeller alone |
| 17 | 1 | 11 | 2.00 | Potassium persulfate | 0.004 | Fullzone impeller alone |
| 18 | 1 | 12 | 2.75 | — | — | Fullzone impeller alone |
| 19 | 1 | 1 | 0.40 | Potassium persulfate | 0.001 | Fullzone impeller alone |
| 20 | 1 | 1 | 7.00 | Potassium persulfate | 0.013 | Fullzone impeller alone |
| 21 | 1 | 13 | 2.75 | Potassium persulfate | 0.004 | Fullzone impeller alone |
| 22 | 1 | 14 | 2.75 | Potassium persulfate | 0.007 | Fullzone impeller alone |
| 23 | 1 | 15 | 5.00 | Potassium persulfate | 0.012 | Fullzone impeller alone |
| 24 | 1 | 2 | 0.60 | Potassium persulfate | 0.001 | Combined use of Fullzone |
| | | | | | | impeller and homogenizer |
| 25 | 1 | 9 | 2.75 | Potassium persulfate | 0.005 | Fullzone impeller alone |

| | Type of external additive | | | |
|---|---|---|---|---|
| | | Amount | | Amount |
| Toner | Type | [parts] | Type | [parts] |
| 1 | Fine silicone particle | 0.4 | — | — |
| 2 | Fine silicone particle | 0.4 | — | — |
| 3 | Fine silicone particle | 0.4 | — | — |
| 4 | Fine silicone particle | 0.4 | — | — |
| 5 | Fine silicone particle | 0.4 | — | — |
| 6 | Fine silicone particle | 0.4 | — | — |
| 7 | Fine silicone particle | 0.4 | — | — |
| 8 | Fine silicone particle | 0.4 | — | — |
| 9 | Fine silicone particle | 0.4 | — | — |
| 10 | Fine silicone particle | 0.4 | — | — |
| 11 | Fine silicone particle | 0.4 | Zinc stearate | 2.0 |
| 12 | Fine silicone particle | 0.4 | — | — |
| 13 | Fine silicone particle | 0.4 | — | — |
| 14 | Fine silicone particle | 0.4 | Zinc stearate | 1.0 |
| 15 | Fine silicone particle | 0.4 | — | — |
| 16 | — | — | — | — |
| 17 | Fine silicone particle | 0.4 | — | — |
| 18 | Fine silicone particle | 0.4 | Zinc stearate | 0.3 |
| 19 | Fine silicone particle | 0.4 | — | — |
| 20 | Fine silicone particle | 0.4 | — | — |
| 21 | Fine silicone particle | 0.4 | — | — |
| 22 | Fine silicone particle | 0.4 | — | — |
| 23 | Fine silicone particle | 0.4 | — | — |
| 24 | Fine silicone particle | 0.4 | — | — |
| 25 | Fine silicone particle | 0.4 | — | — |

TABLE 3-1

| | | Cohesion | Cohesion | | | | | Ratio of | |
|---|---|---|---|---|---|---|---|---|---|
| | | cluster | cluster | | | | | toner | |
| | | number | number | | | | Area | particles | |
| | Initial | percentage | percentage | | | Feret | fraction of | satisfying | Ratio of |
| | cohesion | after | after | | | diameter | binder | dispersed | particles |
| | cluster | treatment | treatment | | | of | component | state (a) of | with size |
| | number | under | under | | | cohesion | of | resin in | of less |
| | percentage | condition A | condition B | | | cluster | cohesion | cohesion | than 4 μm |
| Toner | Cl | Ca | Cb | | | Ag | cluster | cluster | YA |
| No. | [number %] | [number %] | [number %] | Ca/Cl | Cb/Cl | [μm] | [%] | [number %] | [number %] |
| 1 | 6.4 | 6.3 | 0.2 | 0.99 | 0.30 | 4.1 | 39.7 | 85 | 30 |
| 2 | 1.0 | 1.0 | 0.1 | 0.99 | 0.10 | 2.7 | 39.7 | 81 | 30 |
| 3 | 15.0 | 14.3 | 0.5 | 0.95 | 0.30 | 7.2 | 39.7 | 81 | 30 |
| 4 | 8.1 | 7.3 | 0.1 | 0.90 | 0.10 | 3.7 | 39.7 | 80 | 30 |
| 5 | 6.9 | 6.9 | 0.7 | 1.00 | 0.40 | 4.0 | 39.7 | 82 | 30 |
| 6 | 10.1 | 9.6 | 0.1 | 0.95 | 0.10 | 7.9 | 39.7 | 82 | 38 |
| 7 | 4.3 | 3.9 | 0.3 | 1.00 | 0.40 | 1.0 | 39.7 | 81 | 24 |
| 8 | 4.8 | 4.8 | 0.4 | 1.00 | 0.38 | 7.6 | 50.2 | 83 | 35 |
| 9 | 7.2 | 6.6 | 0.7 | 0.91 | 0.10 | 1.4 | 4.9 | 65 | 25 |
| 10 | 6.4 | 6.3 | 2.4 | 0.99 | 0.38 | 4.1 | 39.7 | 82 | 25 |
| 11 | 6.4 | 5.9 | 0.8 | 0.92 | 0.12 | 4.2 | 39.7 | 81 | 40 |
| 12 | 7.0 | 7.0 | 2.7 | 1.00 | 0.38 | 4.2 | 39.7 | 83 | 19 |
| 13 | 7.0 | 6.4 | 0.7 | 0.91 | 0.10 | 4.2 | 39.7 | 84 | 51 |
| 14 | 8.9 | 8.9 | 3.4 | 1.00 | 0.38 | 4.1 | 39.7 | 81 | 25 |
| 15 | 4.3 | 3.9 | 0.5 | 0.91 | 0.12 | 5.0 | 20.0 | 82 | 30 |
| 16 | 6.4 | 6.3 | 1.9 | 0.99 | 0.30 | 4.5 | 39.7 | 83 | 30 |
| 17 | 7.0 | 6.4 | 0.7 | 0.91 | 0.10 | 1.1 | 5.5 | 49 | 25 |
| 18 | — | — | — | — | — | — | — | — | 20 |
| 19 | 0.5 | 0.5 | 0.2 | 0.99 | 0.38 | 4.1 | 39.7 | 81 | 30 |
| 20 | 16.0 | 14.2 | 1.6 | 0.89 | 0.10 | 7.3 | 39.7 | 81 | 30 |
| 21 | 7.1 | 6.2 | 0.7 | 0.87 | 0.10 | 4.2 | 39.7 | 82 | 30 |
| 22 | 6.0 | 5.9 | 2.5 | 0.99 | 0.42 | 4.1 | 39.7 | 81 | 30 |
| 23 | 10.0 | 9.5 | 0.9 | 0.95 | 0.09 | 0.9 | 39.7 | 84 | 38 |
| 24 | 1.0 | 1.0 | 0.4 | 1.00 | 0.40 | 8.1 | 39.4 | 83 | 24 |
| 25 | 4.3 | 4.3 | 2.2 | 1.00 | 0.50 | 5.0 | 39.7 | 80 | 21 |

TABLE 3-2

| | | Area fraction of | |
|---|---|---|---|
| | Fatty acid metal salt | fatty acid metal salt in | |
| Toner | content | cohesion cluster | Type of fatty acid |
| No. | [mass %] | [%] | metal salt |
| 1 | 0.30 | 10.0 | Zinc stearate |
| 2 | 0.30 | 10.0 | Zinc stearate |
| 3 | 0.30 | 10.0 | Zinc stearate |
| 4 | 0.30 | 10.0 | Zinc stearate |
| 5 | 0.30 | 10.0 | Zinc stearate |
| 6 | 0.30 | 5.0 | Zinc stearate |
| 7 | 0.30 | 20.0 | Zinc stearate |
| 8 | 0.30 | 7.0 | Zinc stearate |
| 9 | 0.30 | 20.0 | Zinc stearate |
| 10 | 0.09 | 3.0 | Zinc stearate |
| 11 | 3.10 | 25.0 | Zinc stearate |
| 12 | 0.30 | 10.0 | Zinc stearate |
| 13 | 0.30 | 10.0 | Zinc stearate |
| 14 | 1.00 | 1.8 | Zinc stearate |
| 15 | 0.90 | 30.1 | Zinc stearate |
| 16 | 0.30 | 10.0 | Zinc stearate |
| 17 | 0.30 | 20.0 | Zinc stearate |
| 18 | 0.30 | — | Zinc stearate |
| 19 | 0.30 | 10.0 | Zinc stearate |
| 20 | 0.30 | 10.0 | Zinc stearate |
| 21 | 0.30 | 10.0 | Zinc stearate |
| 22 | 0.30 | 10.0 | Zinc stearate |
| 23 | 0.30 | 5.0 | Zinc stearate |
| 24 | 0.30 | 20.0 | Zinc stearate |
| 25 | — | — | None |

### Example 1

The obtained toner 1 was evaluated as described below.

An HP Color Laser jet Enterprise M653dn was prepared as an electrophotographic apparatus, and a black cartridge was filled with the toner 1. Note that, in consideration of a further increase in the speed and a longer lifetime of printers in the future, M653dn was modified so as to have a process speed of 400 mm/s and used. A4 color laser copy paper (manufactured by CANON KABUSHIKI KAISHA, 80 g/m²) was used as evaluation paper.

### Development Stripe Evaluation in Normal-Temperature, Normal-Humidity and High-Temperature, High-Humidity Environments

Development stripes due to toner melt adhesion in a developing portion were evaluated in a normal-temperature, normal-humidity environment (25° C./50% RH) and a high-temperature, high-humidity environment (30° C./80% RH). Supposing a long-term durability test, a horizontal line pattern with a printing ratio of 1% was printed on two sheets per job, and a mode was set such that the apparatus was stopped once between the jobs and the next job was then started. In each of the environments, an image forming test was performed in this mode on a total of 30,000 sheets, a half-tone image (H.T. image) was then printed, and the number of stripes on the image was counted. Furthermore, to check whether the stripes were development stripes, stripes on a developing roller were also checked to check the presence of stripes that matched the stripes on the image. In the present disclosure, the following rank B or higher was determined to be acceptable for practical use.
A: The number of stripes is zero.
B: The number of stripes is one.
C: The number of stripes is two or three.
D: The number of stripes is four or more.

### Evaluation of Charging Roller Soiling

Charging roller soiling was evaluated in the normal-temperature, normal-humidity environment (25° C./50% RH). Supposing a long-term durability test, a horizontal line pattern with a printing ratio of 1% was printed on two sheets per job, and a mode was set such that the apparatus was stopped once between the jobs and the next job was then started. An image forming test was performed in this mode on a total of 30,000 sheets, and the surface of a charging roller and a half-tone image after the test were visually observed and evaluated on the basis of the following criteria. In the present disclosure, the following rank B or higher was determined to be acceptable for practical use.
A: No defects are observed on the surface of the charging roller or the image.
B: Soiling is slightly observed on the surface of the charging roller, but it does not appear on the image.
C: Soiling is observed on the surface of the charging roller, and image density unevenness also starts to be noticeable.
D: Soiling is observed on the surface of the charging roller, and it can be confirmed that uneven density is also clearly observed on the image.

### Examples 2 to 17 and Comparative Examples 1 to 8

The evaluation was performed as in Example 1 except that the toner loaded in the cartridge was changed as shown in Table 4. The evaluation results are shown in Table 4.

TABLE 4

| | | | | Normal-temperature, | | High-temperature, | | |
|---|---|---|---|---|---|---|---|---|
| | | | | normal-humidity | | high-humidity | | Electroconductive |
| | | | | development stripe | | development stripe | | member |
| | | | | H.T. image | | H.T. image | | soiling/uneven |
| | Toner | | | stripe | | stripe | | density |
| | No. | Ca/Cl | Cb/Cl | [stripes] | Evaluation | [stripes] | Evaluation | Evaluation |
| Example 1 | 1 | 0.99 | 0.30 | 0 | A | 0 | A | A |
| Example 2 | 2 | 0.99 | 0.10 | 0 | A | 1 | B | A |
| Example 3 | 3 | 0.95 | 0.30 | 0 | A | 0 | A | B |
| Example 4 | 4 | 0.90 | 0.10 | 0 | A | 1 | B | B |
| Example 5 | 5 | 1.00 | 0.40 | 1 | B | 1 | B | A |
| Example 6 | 6 | 0.95 | 0.10 | 0 | A | 1 | B | A |
| Example 7 | 7 | 1.00 | 0.40 | 1 | B | 0 | A | B |
| Example 8 | 8 | 1.00 | 0.38 | 1 | B | 1 | B | A |
| Example 9 | 9 | 0.91 | 0.10 | 1 | B | 1 | B | B |
| Example 10 | 10 | 0.99 | 0.38 | 0 | A | 1 | B | A |
| Example 11 | 11 | 0.92 | 0.12 | 0 | A | 0 | A | B |
| Example 12 | 12 | 1.00 | 0.38 | 1 | B | 1 | B | A |
| Example 13 | 13 | 0.91 | 0.10 | 0 | A | 0 | A | B |
| Example 14 | 14 | 1.00 | 0.38 | 0 | A | 1 | B | A |
| Example 15 | 15 | 0.91 | 0.12 | 1 | B | 1 | B | B |
| Example 16 | 16 | 0.99 | 0.30 | 1 | B | 1 | B | A |
| Example 17 | 17 | 0.91 | 0.10 | 1 | B | 2 | C | B |
| Comparative | 18 | — | — | 1 | B | 4 | D | D |
| Example 1 | | | | | | | | |
| Comparative | 19 | 0.99 | 0.38 | 2 | C | 4 | D | A |
| Example 2 | | | | | | | | |
| Comparative | 20 | 0.89 | 0.10 | 0 | A | 0 | A | C |
| Example 3 | | | | | | | | |
| Comparative | 21 | 0.87 | 0.10 | 2 | C | 4 | D | C |
| Example 4 | | | | | | | | |
| Comparative | 22 | 0.99 | 0.42 | 3 | C | 3 | C | A |
| Example 5 | | | | | | | | |
| Comparative | 23 | 0.95 | 0.09 | 3 | C | 1 | B | C |
| Example 6 | | | | | | | | |
| Comparative | 24 | 1.00 | 0.40 | 1 | B | 3 | C | B |
| Example 7 | | | | | | | | |
| Comparative | 25 | 1.00 | 0.50 | 1 | B | 3 | C | A |
| Example 8 | | | | | | | | |

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-203618, filed Dec. 1, 2023, which is hereby incorporated by reference herein in its entirety.

What is claimed is:

1. A toner comprising:
toner particles,
wherein a cohesion cluster containing fine silica particles and a binder component is present on surfaces of the toner particles, and the toner further comprises particles of a fatty acid metal salt,
an arithmetic mean value Ag of a Feret diameter of the cohesion cluster is 1,000 nm or more and 8,000 nm or less,
a number percentage of toner particles having the cohesion cluster is represented by CI (number %), CI is 1 number % or more and 15 number % or less, and
a number percentage of toner particles having the cohesion cluster in the toner after being treated under an ultrasonic wave condition A is represented by Ca (number %), and a number percentage of toner particles having the cohesion cluster in the toner after being treated under an ultrasonic wave condition B is represented by Cb (number %),
CI, Ca, and Cb satisfy formulae (1) and (2):
ultrasonic wave condition A: output frequency 30 kHz, output capacity 0.75 W, and irradiation time 300 s
ultrasonic wave condition B: output frequency 30 kHz, output capacity 25 W, and irradiation time 300 s
$$0.9 \leq Ca / CI \leq 1. \qquad Formula ( 1 )$$
$$0.1 \leq Cb / CI \leq 0 \text{.40} . \qquad Formula ( 2 )$$

2. The toner according to claim 1, wherein the particles of the fatty acid metal salt are included in the cohesion cluster or present on the surfaces of the toner particles.

3. The toner according to claim 1, wherein on a surface of a toner particle having the cohesion cluster observed with a scanning electron microscope, an area fraction of the binder component of the cohesion cluster is 5% or more and 50% or less relative to an entirety of the cohesion cluster.

4. The toner according to claim 1, wherein the toner comprises the particles of the fatty acid metal salt in an amount of 0.1% by mass or more and 3.0% by mass or less.

5. The toner according to claim 1, wherein when a dispersion liquid prepared by treating the toner under the ultrasonic wave condition A is measured with a flow particle image measuring apparatus, a presence ratio YA (number %) of particles with a size of less than 4 μm is 20 number % or more and 50 number % or less.

6. The toner according to claim 1, wherein on a surface of a toner particle having the cohesion cluster observed with a scanning electron microscope, an area fraction of the fatty acid metal salt of the cohesion cluster is 2% or more and 30% or less relative to an entirety of the cohesion cluster.

7. The toner according to claim 1, comprising fine silicone resin particles on the surfaces of the toner particles as an external additive.
